(19) United States
(12) Patent Application Publication
(10) Pub. No.: US 2024/0384063 A1
(43) Pub. Date: Nov. 21, 2024

(54) MELT-PROCESSABLE CELLULOSE ACETATE COMPOSITIONS, MELTS AND MELT-FORMED ARTICLES MADE THEREFROM

(71) Applicant: Eastman Chemical Company, Kingsport, TN (US)

(72) Inventors: STEPHANIE KAY CLENDENNEN, KINGSPORT, TN (US); STEVEN THOMAS PERRI, KINGSPORT, TN (US); MONIKA KARIN WIEDMANN BOGGS, KINGSPORT, TN (US); HAMID EBRAHIMI, KINGSPORT, TN (US)

(73) Assignee: Eastman Chemical Company, Kingsport, TN (US)

(21) Appl. No.: 18/688,502

(22) PCT Filed: Sep. 1, 2022
(86) PCT No.: PCT/US2022/042293

§ 371 Date: Mar. 1, 2024

Related U.S. Application Data
(60) Provisional application No. 63/260,889, filed on Sep. 3, 2021.

(51) Int. Cl. C08K 5/09; C08J 9/00; C08J 9/12; C08K 5/101

(52) U.S. Cl. CPC C08K 5/09; C08J 9/0023; C08J 9/122; C08K 5/101; C08J 2203/06; C08J 2301/12

(57) ABSTRACT

A melt-processable cellulose acetate composition is disclosed. The melt-processable cellulose acetate composition of the present invention includes (i) cellulose acetate: (ii) a plasticizing amount of plasticizer; and (iii) fatty acid. Cellulose acetate melts and melt-formed articles are also described.

### BACKGROUND OF THE INVENTION

There is a well-known global issue with waste disposal, particularly of large volume consumer products such as plastics or polymers that are not considered biodegradable within acceptable temporal limits. There is a public desire to incorporate these types of wastes into renewed products through recycling, reuse, or otherwise reducing the amount of waste in circulation or in landfills. This is especially true for single-use plastic articles/materials.

As consumer sentiment regarding the environmental fate of single-use plastics, such as straws, cutlery, to-go cups, and plastic bags, are becoming a global trend, plastics bans are being considered/enacted around the world in both developed and developing nations. Bans have extended from plastic shopping bags into straws, cutlery, and clamshell packaging, for example, in the U.S. alone. Other countries have taken even more extreme steps, such as the list of ten single-use articles slated to be banned, restricted in use, or mandated to have extended producer responsibilities throughout the EU. As a result, industry leaders, brand owners, and retailers have made ambitious commitments to implement compostable and/or biodegradable materials in the coming years.

Use of biodegradable and/or compostable materials in the manufacture of such single-use articles, though highly desirable from an environmental perspective, can present particular problems for article manufacturers. Most such articles have been manufactured historically using non-biodegradable, fossil fuel-based materials such as polystyrene and employ melt processing techniques such as casting, extrusion and injection molding, wherein the material is melted into flowable form, processed and cooled to form a functional article. Utilizing biodegradable raw material, such as some cellulose acetates, in existing manufacturing systems without significant equipment replacement, modification or retrofit costs is difficult. Further, changes in processing conditions that may be necessitated by use of biodegradable materials can negatively impact efficiency and material yields. In addition, the melt-processing steps for converting cellulose acetate to useful articles can require heating the formulation to temperatures that may result in color formation, loss of compositional components such as plasticizers and loss in molecular weight of the polymer, all of which can affect the heat stability, toughness, flexibility and other performance parameters of the final article.

There is an unmet market need for single-use consumer products that have adequate performance and melt-processing properties for their intended use and that are compostable and/or biodegradable.

It would also be beneficial to provide products having such properties and that also have significant content of renewable, recycled, and/or re-used material.

### SUMMARY OF THE INVENTION

Applicants have unexpectedly discovered that certain melt-processable cellulose acetate compositions are surprisingly advantageous for use in manufacture of melt-formed biodegradable articles and biodegradable article components with unexpected processability and article property benefits.

In various interrelated aspects and embodiments, the present application discloses melt-processable compositions; melts; foamable compositions for making foams; articles, including melt-formed articles and articles including, formed from or prepared from melt-processable compositions and related foamable compositions. One of ordinary skill will understand and appreciate that elements or features used to describe one aspect or embodiment may be applicable and useful in describing other embodiments. By way of non-limiting example, the description of a cellulose acetate set forth in the context of the composition of the present invention is also applicable and useful in describing cellulose acetate in the context of melts, extruded, molded, thermoformed or foamable compositions and articles of the present invention. Accordingly, descriptions and disclosure relating to elements or features of an aspect or embodiment of the present invention are hereby expressly relied on to describe and support those elements or features in other aspects or embodiments.

In one aspect, the present application discloses a melt-processable, cellulose acetate composition. The melt-processable, cellulose acetate composition of the present invention includes (i) cellulose acetate; (ii) fatty acid; and (iii) an optional processing aid.

In another aspect, the present application discloses a cellulose acetate melt, useful in particular for forming melt-formed articles. The cellulose acetate melt of the present invention includes (i) cellulose acetate; (ii) fatty acid; and (iii) an optional processing aid.

In yet another aspect, the present application discloses a melt-formed article. The melt-formed article of the present invention is formed from a cellulose acetate melt that includes (i) cellulose acetate; (ii) fatty acid; and optionally (iii) a processing aid. The melt-formed biodegradable article of the present invention includes (i) cellulose acetate; (ii) fatty acid; and optionally (iii) a processing aid.

The present application also discloses additional compositions, melts, articles, and methods in various aspects.

### DETAILED DESCRIPTION OF THE INVENTION

In a first aspect, the present invention is directed to a melt-processable, cellulose acetate composition. The melt-processable, cellulose acetate composition of the present invention includes (i) cellulose acetate; (ii) fatty acid, and (iii) an optional processing aid.

In one or more embodiments, the cellulose acetate is present in the melt-processable, cellulose acetate composition in an amount of from 50% to 97% by weight or from 55% to 95% by weight or from 60% to 90% by weight based on the total weight of the melt-processable, cellulose acetate composition. Cellulose acetates that may be useful for the present invention generally comprise repeating units of the structure:

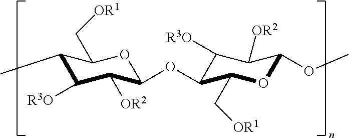

Wherein R1, R2, and R3 are selected independently from the group consisting of hydrogen or acetyl. For cellulose esters, the substitution level is usually expressed in terms of degree of substitution (DS), which is the average number of non-OH substituents per anhydroglucose unit (AGU). Generally, conventional cellulose contains three hydroxyl groups in each AGU unit that can be substituted; therefore, DS can have a value between zero and three. Native cellulose is a large polysaccharide with a degree of polymerization from 250-5,000 even after pulping and purification, and thus the assumption that the maximum DS is 3.0 is approximately correct. Because DS is a statistical mean value, a value of 1 does not assure that every AGU has a single substituent. In some cellulose acetates, there can be unsubstituted anhydroglucose units, some with two and some with three substituents, and typically the value will be a non-integer. Total DS is defined as the average number of all of substituents per anhydroglucose unit. The degree of substitution per AGU can also refer to a particular substituent, such as, for example, hydroxyl or acetyl. In embodiments, n is an integer in a range from 25 to 250, or 25 to 200, or 25 to 150, or 25 to 100, or 25 to 75. Cellulose acetates useful in embodiments of the present invention can have a degree of substitution in the range of from 1.0 to 2.5. In some cellulose acetates, the cellulose acetate as described herein may have an average degree of substitution of at least about 1.0, 1.05, 1.1, 1.15, 1.2, 1.25, 1.3, 1.35, 1.4, 1.45 or 1.5 and/or not more than about 2.5, 2.45, 2.4, 2.35, 2.3, 2.25, 2.2, 2.15, 2.1, 2.05, 2.0, 1.95, 1.9, 1.85, 1.8 or 1.75.

In embodiments of the invention, the cellulose acetates have at least 2 anhydroglucose rings and can have between at least 50 and up to 5,000 anhydroglucose rings, or at least 50 and less than 150 anhydroglucose rings. The number of anhydroglucose units per molecule is defined as the degree of polymerization (DP) of the cellulose acetate. In embodiments, cellulose acetate may have an inherent viscosity (IV) of about 0.2 to about 3.0 deciliters/gram, or about 0.5 to about 1.8, or about 1 to about 1.5, as measured at a temperature of 25° C. for a 0.25 gram sample in 100 ml of a 60/40 by weight solution of phenol/tetrachloroethane. In embodiments, cellulose acetates useful herein can have a DS/AGU of about 1 to about 2.5, or 1 to less than 2.2, or 1 to less than 1.5, and the substituting acyl is acetyl.

Cellulose acetates useful in the present invention may be biodegradable. The term “biodegradable” generally refers to the biological conversion and consumption of organic molecules. Biodegradability is an intrinsic property of the material itself, and the material cellulose acetate exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in a standard test method. The melt-processable compositions and the melts of the present invention, in one or more embodiments, may be biodegradable.

Cellulose acetates of the present invention may be produced by any method known in the art. Examples of processes for producing cellulose esters generally are taught in Kirk-Othmer, Encyclopedia of Chemical Technology, 5th Edition, Vol. 5, Wiley-Interscience, New York (2004), pp. 394-444. Cellulose, the starting material for producing cellulose acetates, may be obtained in different grades and sources such as from cotton linters, softwood pulp, hardwood pulp, corn fiber and other agricultural sources, and bacterial cellulose, among others.

One method of producing cellulose acetates is esterification of the cellulose by mixing cellulose with the appropriate organic acids, acid anhydrides, and cellulose catalysts. Cellulose is then converted to a cellulose triester. Ester hydrolysis is then performed by adding a water-acid mixture to the cellulose triester, which can then be filtered to remove any gel particles or fibers. Water is then added to the mixture to precipitate the cellulose ester. The cellulose ester may then be washed with water to remove reaction by-products followed by dewatering and drying.

The cellulose triesters to be hydrolyzed can have three acetyl substituents. These cellulose esters may be prepared by a number of methods known to those skilled in the art. For example, cellulose esters may be prepared by heterogeneous acylation of cellulose in a mixture of carboxylic acid and anhydride in the presence of a cellulose catalyst such as H2SO4. Cellulose triesters may also be prepared by the homogeneous acylation of cellulose dissolved in an appropriate solvent such as LiCl/DMAc or LiCl/NMP.

Those skilled in the art will understand that the commercial term of cellulose triesters also encompasses cellulose esters that are not completely substituted with acyl groups. For example, cellulose triacetate commercially available from Eastman Chemical Company, Kingsport, TN, U.S.A., typically has a DS from about 2.85 to about 2.99.

After esterification of the cellulose to the triester, part of the acyl substituent may be removed by hydrolysis or by alcoholysis to give a secondary cellulose ester. As noted previously, depending on the particular method employed, the distribution of the acyl substituents may be random or non-random. Secondary cellulose esters may also be prepared directly with no hydrolysis by using a limiting amount of acylating reagent. This process is particularly useful when the reaction is conducted in a solvent that will dissolve cellulose. All of these methods yield cellulose esters that are useful in this invention.

In one embodiment or in combination with any of the mentioned embodiments, or in combination with any of the mentioned embodiments, the cellulose acetates of the present invention are cellulose diacetates. The cellulose diacetates may have a polystyrene equivalent number average molecular weight (Mn) from about 10,000 to about 100,000 as measured by gel permeation chromatography (GPC) using NMP as solvent and polystyrene equivalent Mn according to ASTM D6474. In other aspects or embodiments of the present invention described herein, the melt-processable, biodegradable cellulose acetate composition of the present invention includes cellulose diacetate having a polystyrene equivalent number average molecular weights (Mn) from 10,000 to 90,000; or 10,000 to 80,000; or 10,000 to 70,000; or 10,000 to 60,000; or 10,000 to less than 60,000; or 10,000 to less than 55,000; or 10,000 to 50,000; or 10,000 to less than 50,000; or 10,000 to less than 45,000; or 10,000 to 40,000; or 10,000 to 30,000; or 20,000 to less than 60,000; or 20,000 to less than 55,000; or 20,000 to 50,000; or 20,000 to less than 50,000; or 20,000 to less than 45,000; or 20,000 to 40,000; or 20,000 to 35,000; or 20,000 to 30,000; or 30,000 to less than 60,000; or 30,000 to less than 55,000; or 30,000 to 50,000; or 30,000 to less than 50,000; or 30,000 to less than 45,000; or 30,000 to 40,000; or 30,000 to 35,000; as measured by gel permeation chromatography (GPC) using NMP as solvent and according to ASTM D6474. In embodiments, the cellulose acetate may have a number average molecular weight (Mn) of not more than 100,000, or not more than 90,000, measured using gel permeation chromatography with a polystyrene equivalent and using N-methyl-2-pyrrolidone (NMP) as the solvent. In some cellulose acetates, the biodegradable cellulose acetate may have a Mn of at least about 10,000, at least about 20,000, 25,000, 30,000, 35,000, 40,000, or 45,000 and/or not more than about 100,000, 95,000, 90,000, 85,000, 80,000, 75,000, 70,000, 65,000, 60,000, or 50,000.

The most common commercial secondary cellulose esters are prepared by initial acid catalyzed heterogeneous acylation of cellulose to form the cellulose triester. After a homogeneous solution in the corresponding carboxylic acid of the cellulose triester is obtained, the cellulose triester is then subjected to hydrolysis until the desired degree of substitution is obtained. After isolation, a random secondary cellulose ester is obtained. That is, the relative degree of substitution (RDS) at each hydroxyl is roughly equal.

In embodiments of the invention, the cellulose acetate may be prepared by converting cellulose to a cellulose ester with reactants that are obtained from recycled materials, e.g., a recycled plastic content syngas source. In embodiments, such reactants may be cellulose reactants that include organic acids and/or acid anhydrides used in the esterification or acylation reactions of the cellulose, e.g., as discussed herein.

The cellulose acetates of the present invention may be produced in any physical form that is desirable for downstream processing into compositions, melts and useful articles. In one or more embodiments, the biodegradable melt-stable cellulose acetate is in the form of a powder. In one or more embodiments, the biodegradable melt-stable cellulose acetate is in the form of a flake or pellet.

In one or more embodiments, the melt-processable cellulose acetate composition includes at least one recycle cellulose acetate. In one or more embodiments, the recycle cellulose acetate includes at least one substituent on an anhydroglucose unit (AU) derived from recycled content material, e.g., recycled plastic content syngas. Recycle cellulose acetates and methods for their manufacture are described for example in present assignee's PCT

Published Applications WO2020/242921; WO2021/061918A1; WO2021/092296A1 and U.S. Published Patent Application No. 2020/0247910, all expressly incorporated herein by reference.

The melt-processable, cellulose acetate composition of the present invention may further include one or more additional cellulose esters. Non-limiting examples of such additional cellulose esters include cellulose mixed esters (e.g., CAB, CAP), cellulose acetate with a DS higher or lower than described, or a cellulose acetate with a molecular weight higher or lower than described.

The melt-processable, cellulose acetate composition of the present invention further optionally includes a processing aid. In one or more embodiments, the composition includes a processing aid and the processing aid includes plasticizer. Plasticizers may be used singly, or in a combination of two or more. The plasticizer reduces the melt temperature, the Tg, and/or the melt viscosity of the cellulose acetate. In embodiments, the plasticizer is a food-compliant plasticizer. By food-compliant is meant compliant with applicable food additive and/or food contact regulations where the plasticizer is cleared for use or recognized as safe by at least one (national or regional) food safety regulatory agency (or organization), for example listed in the 21 CFR Food Additive Regulations or otherwise Generally Recognized as Safe (GRAS) by the US FDA. In embodiments, the food-compliant plasticizer is triacetin. In embodiments, examples of food-compliant plasticizers that could be considered may include triacetin, triethyl citrate, polyethylene glycol, benzoic acid esters (e.g. Benzoflex), propylene glycol, acetylated triethyl citrate, acetyl tributyl citrate, polymeric plasticizers (e.g. Admex), tripropionin, tributyrin, Saciflex, poloxamer copolymers, polyethylene glycol esters and ethers (e.g. PEG succinate), adipate esters (e.g. diisobutyl adipate), polyvinyl pyrollidone, glycerol tribenzoate and combinations thereof. In one or more embodiments, the plasticizer may be selected from the group consisting of triacetin, polyethylene glycol having an average weight average molecular weight of from 300 to 1000 Da and combinations thereof. The phrase “plasticizing amount” includes amounts of plasticizer that are sufficient to plasticize the cellulose acetate present in the melt-processable cellulose acetate composition to facilitate formation of a melt and melt processing into useful articles. One of ordinary skill will appreciate that the specific amount of plasticizer that may constitute a “plasticizing amount” may depend on a number of factors such as for example cellulose acetate selection and the selection and amount of optional additives present in the composition. For example, the presence of certain processing aids such as compatible polymers, solvents, and foaming agents in the composition can reduce the amount plasticizer necessary to plasticize the cellulose acetate. In embodiments, the plasticizer may be present in an amount sufficient to permit the melt-processable, biodegradable cellulose acetate composition to be melt processed (or thermally formed) into useful articles, e.g., single use plastic articles, in conventional melt processing equipment.

In embodiments, the plasticizer may be present in an amount from 1 to 40 wt % for most thermoplastics processing. The amount of plasticizer may vary based on a number of factors that include the type of thermal processing or melt processing used to make an article from the composition. Non-limiting processing examples include extrusion such as profile extrusion and sheet extrusion; injection molding; compression molding; blow molding; thermoforming; and the like. Accordingly, articles that may include or be formed from or be prepared using the composition may include extruded articles such as profile extruded articles and sheet extruded articles; injection molded articles; compression molded articles; blow molded articles; thermoformed articles; and the like. In embodiments, the cellulose acetate composition comprises at least one plasticizer (as described herein) in an amount from 1 to 40 wt %, or 5 to 40 wt %, or 5% to 30%, or 10 to 40 wt %, or 13 to 40 wt %, or 15 to 50 wt % or 15 to 40 wt %, or 17 to 40 wt %, or 20 to 40 wt %, or 25 to 40 wt %, or 5 to 35 wt %, or 10 to 35 wt %, or 13 to 35 wt %, or 15 to 35 wt %, or greater than 15 to 35 wt %, or 17 to 35 wt %, or 20 to 35 wt %, or 5 to 30 wt %, or 10 to 30 wt %, or 13 to 30 wt %, or 15 to 30 wt %, or greater than 15 to 30 wt %, or 17 to 30 wt %, or 5 to 25 wt %, or 10 to 25 wt %, or 13 to 25 wt %, or 15 to 25 wt %, or greater than 15 to 25 wt %, or 17 to 25 wt %, or 5 to 20 wt %, or 10 to 20 wt %, or 13 to 20 wt %, or 15 to 20 wt %, or greater than 15 to 20 wt %, or 17 to 20 wt %, or 5 to 17 wt %, or 10 to 17 wt %, or 13 to 17 wt %, or 15 to 17 wt %, or greater than 15 to 17 wt %, or 5 to less than 17 wt %, or 10 to less than 17 wt %, or 13 to less than 17 wt %, or 15 to less than 17 wt %, all based on the total weight of the melt-processable cellulose acetate composition. In embodiments, the at least one plasticizer includes or is a food-compliant plasticizer. In one or more embodiments, the food-compliant plasticizer includes or is triacetin.

In embodiments, the plasticizer is a biodegradable plasticizer. Some examples of biodegradable plasticizers include triacetin, tripripoionin, triethyl citrate, acetyl triethyl citrate, polyethylene glycol, the benzoate containing plasticizers such as the Benzoflex™ plasticizer series, poly (alkyl succinates) such as poly (butyl succinate), polyethersulfones, adipate based plasticizers, soybean oil epoxides such as the Paraplex™ plasticizer series, sucrose based plasticizers, dibutyl sebacate, tributyrin, the Resoflex™ series of plasticizers, triphenyl phosphate, glycolates, polyethylene glycol ester and ethers, 2,2,4-trimethylpentane-1,3-diyl bis(2-methylpropanoate), polycaprolactones and combinations thereof. In one or more embodiments, the plasticizer includes a plasticizer with recycle content.

The melt-processable cellulose acetate composition of the present invention includes fatty acid. In one or more embodiments, fatty acid is present in an amount of no more than 5% by weight or no more than 4% by weight or no more than 3% by weight or from 0.5 to 5% by weight or from 1 to 4% by weight or from 1 to 3% by weight, all based on the total weight of said melt-processable cellulose acetate composition.

In one or more embodiments, the fatty acid is miscible with one or more of cellulose acetates, cellulose esters and cellulose mixed esters in native or plasticized form. In one or more embodiments, the fatty acid has an alkyl chain length range of from C8 to C22 or from C12 to C18 or from C12 to C16 or from C12 to C14. In one or more embodiments, the fatty acid has a linear, unbranched alkyl chain. In one or more embodiments, the fatty acid has a branched alkyl chain. In one or more embodiments, the fatty acid has a saturated alkyl chain. In one or more embodiments, the fatty acid has an unsaturated alkyl chain. In one or more embodiments, said fatty acid is selected from the group consisting of lauric acid, myristic acid, palmitic acid, stearic acid and blends thereof. In one or more embodiments, the fatty acid is a fatty acid blend wherein at least one of the fatty acid components of said eutectic blend has an alkyl chain length of C14 or less.

In one or more embodiments, the fatty acid is a eutectic blend of two or more fatty acids. As used herein, the term “eutectic” is defined to include blends wherein the melting point of the blend is lower than any individual fatty acid in the blend. In one or more embodiments, the fatty acid is a eutectic blend having a melt temperature below 50° C. In one or more embodiments, the eutectic blend is a binary eutectic blend. In one or more embodiments, the eutectic blend is a tertiary eutectic blend. In one or more embodiments, the fatty acid is a eutectic blend wherein fatty acid components of said eutectic blend have an alkyl chain length of no more than C17. In one or more embodiments, the eutectic blend is a ternary eutectic blend. In one or more embodiments, the fatty acid is a eutectic blend wherein at least one of the fatty acid components of said eutectic blend has an alkyl chain length of C14 or less.

In one or more embodiments, the fatty acid is a fatty acid blend with an onset melt temperature below 70° C. In one or more embodiments, the fatty acid is a fatty acid blend and wherein the fatty acid components of said blend have an alkyl chain length no more than C16 or C14.

In one or more embodiments, the fatty acid is a bio-based fatty acid. As used herein, the term “bio-based” includes materials including content derived from renewable biological sources, living (or once-living) organisms or materials or the like. Non-limiting examples of such biological sources include animals, plants such as trees and sugarcane, waxes derived therefrom, starch and the like. Non-limiting sources of bio-based fatty acids include soybean oil, canola oil, palm oil, palm kernel oil or coconut oil.

In one or more embodiments, the melt-processable cellulose acetate compositions of the present invention may include one or more optional additives. Non-limiting examples of additives include UV absorbers, antioxidants, acid scavengers such as epoxidized soybean oil, radical scavengers, an epoxidized oil and combinations thereof, filler, additive, biopolymer, stabilizer, and/or odor modifier waxes, compatibilizers, biodegradation promoters, dyes, pigments, colorants, luster control agents, lubricants, anti-oxidants, viscosity modifiers, antifungal agents, anti-fogging agents, heat stabilizers, impact modifiers, antibacterial agents, softening agents, processing aids, mold release agents, and combinations thereof. It should be noted that the same type of compounds or materials cellulose acetate be identified for or included in multiple categories of components in the cellulose acetate compositions. For example, polyethylene glycol (PEG) could function as a plasticizer or as an additive that does not function as a plasticizer, such as a hydrophilic polymer or biodegradation promotor, e.g., where a lower molecular weight PEG has a plasticizing effect and a higher molecular weight PEG functions as a hydrophilic polymer but without plasticizing effect.

In embodiments, the melt-processable cellulose acetate composition comprises at least one filler. In embodiments, the filler is of a type and present in an amount to enhance biodegradability and/or compostability of an article including, prepared from or formed from the composition. In embodiments, the cellulose acetate composition comprises at least one filler chosen from: carbohydrates (sugars and salts), cellulosic and organic fillers (wood flour, wood fibers, hemp, cellulose carbon, coal particles, graphite, and starches), mineral and inorganic fillers (calcium carbonate, talc, silica, titanium dioxide, glass fibers, glass spheres, boronitride, aluminum trihydrate, magnesium hydroxide, calcium hydroxide, alumina, and clays), food wastes or byproduct (eggshells, distillers grain, and coffee grounds), desiccants (e.g. calcium sulfate, magnesium sulfate, magnesium oxide, calcium oxide), or combinations (e.g., mixtures) of these fillers. In embodiments, the cellulose acetate compositions include at least one filler that also functions as a colorant additive. In embodiments, the colorant additive filler cellulose acetate be chosen from: cellulose carbon, graphite, titanium dioxide, opacifiers, dyes, pigments, toners and combinations thereof. In embodiments, the cellulose acetate compositions include at least one filler that also functions as a stabilizer or flame retardant.

In embodiments, the melt-processable cellulose acetate composition optionally further includes a biodegradable polymer (other than cellulose acetate). In embodiments, the other biodegradable polymer cellulose acetate be chosen from polyhydroxyalkanoates (PHAs and PHBs), polylactic acid (PLA), polycaprolactone polymers (PCL), polybutylene adipate terephthalate (PBAT), polyethylene succinate (PES), polyvinyl acetates (PVAs), polybutylene succinate (PBS) and copolymers (such as polybutylene succinate-co-adipate (PBSA)), cellulose esters, cellulose ethers, starch, proteins, derivatives thereof, and combinations thereof. In embodiments, the cellulose acetate composition comprises two or more biodegradable polymers. In embodiments, the biodegradable polymer (other than cellulose acetate) is present in an amount from 0.1 to less than 50 wt %, or 1 to 40 wt %, or 1 to 30 wt %, or 1 to 25 wt %, or 1 to 20 wt %, based on the cellulose acetate composition. In embodiments, the cellulose acetate composition contains a biodegradable polymer (other than the cellulose acetate) in an amount from 0.1 to less than 50 wt %, or 1 to 40 wt %, or 1 to 30 wt %, or 1 to 25 wt %, or 1 to 20 wt %, based on the total amount of cellulose acetate plus biodegradable polymer. In embodiments, the biodegradable polymer comprises a PHA having a weight average molecular weight (Mw) in a range from 10,000 to 1,000,000, or 50,000 to 1,000,000, or 100,000 to 1,000,000, or 250,000 to 1,000,000, or 500,000 to 1,000,000, or 600,000 to 1,000,000, or 600,000 to 900,000, or 700,000 to 800,000, or 10,000 to 500,000, or 10,000 to 250,000, or 10,000 to 100,000, or 10,000 to 50,000, measured using gel permeation chromatography (GPC) with a refractive index detector and polystyrene standards employing a solvent of methylene chloride. In embodiments, the PHA may include a polyhydroxybutyrate-co-hydroxyhexanoate.

In certain embodiments, the cellulose acetate composition optionally comprises at least one stabilizer. Although it is desirable for the cellulose acetate composition and the articles that include or are formed from them to be composable and/or biodegradable, a certain amount of stabilizer may be added to provide a selected shelf life or stability, e.g., towards light exposure, oxidative stability, or hydrolytic stability. In various embodiments, stabilizers may include UV absorbers, antioxidants (ascorbic acid, BHT, BHA, etc.), other acid and radical scavengers, epoxidized oils, e.g., epoxidized soybean oil, or combinations thereof.

Antioxidants may be classified into several classes, including primary antioxidant, and secondary antioxidant. Primary antioxidants are generally known to function essentially as free radical terminators (scavengers). Secondary antioxidants are generally known to decompose hydroperoxides (ROOH) into nonreactive products before they decompose into alkoxy and hydroxy radicals. Secondary antioxidants are often used in combination with free radical scavengers (primary antioxidants) to achieve a synergistic inhibition effect and secondary AOs are used to extend the life of phenolic type primary AOs.

“Primary antioxidants” are antioxidants that act by reacting with peroxide radicals via a hydrogen transfer to quench the radicals. Primary antioxidants generally contain reactive hydroxy or amino groups such as in hindered phenols and secondary aromatic amines. Examples of primary antioxidants include BHT, Irganox™ 1010, 1076, 1726, 245, 1098, 259, and 1425; Ethanox™ 310, 376, 314, and 330; Evernox™ 10, 76, 1335, 1330, 3114, MD 1024, 1098, 1726, 120. 2246, and 565; Anox™ 20, 29, 330, 70, IC-14, and 1315; Lowinox™ 520, 1790, 22IB46, 22M46, 44B25, AH25, GP45, CA22, CPL,3 HD98, TBM-6, and WSP; Naugard™ 431, PS48, SP, and 445; Songnox™ 1010, 1024, 1035, 1076 CP, 1135 LQ, 1290 PW, 1330FF, 1330 PW, 2590 PW, and 3114 FF; and ADK Stab AO-20, AO-30, AO-40, AO-50, AO-60, AO-80, and AO-330.

“Secondary antioxidants” are often hydroperoxide decomposers. They act by reacting with hydroperoxides to decompose them into nonreactive and thermally stable products that are not radicals. They are often used in conjunction with primary antioxidants. Examples of secondary antioxidants include the organophosphorous (e.g., phosphites, phosphonites) and organosulfur classes of compounds. The phosphorous and sulfur atoms of these compounds react with peroxides to convert the peroxides into alcohols. Examples of secondary antioxidants include Ultranox 626, Ethanox™ 368, 326, and 327; Doverphos™ LPG11, LPG12, DP S-680, 4, 10, S480, S-9228, S-9228T; Evernox™ 168 and 626; Irgafos™ 126 and 168; Weston™ DPDP, DPP, EHDP, PDDP, TDP, TLP, and TPP; Mark™ CH 302, CH 55, TNPP, CH66, CH 300, CH 301, CH 302, CH 304, and CH 305; ADK Stab 2112, HP-10, PEP-8, PEP-36, 1178, 135A, 1500, 3010, C, and TPP; Weston 439, DHOP, DPDP, DPP, DPTDP, EHDP, PDDP, PNPG, PTP, PTP, TDP, TLP, TPP, 398, 399, 430, 705, 705T, TLTTP, and TNPP; Alkanox 240, 626, 626A, 627AV, 618F, and 619F; and Songnox™ 1680 FF, 1680 PW, and 6280 FF.

In embodiments, the melt-processable cellulose acetate composition comprises at least one stabilizer, wherein the stabilizer comprises one or more secondary antioxidants. In embodiments, the stabilizer comprises a first stabilizer component chosen from one or more secondary antioxidants and a second stabilizer component chosen from one or more primary antioxidants, citric acid or a combination thereof.

In embodiments, the stabilizer comprises one or more secondary antioxidants in an amount in the range of from 0.01 to 0.8, or 0.01 to 0.7, or 0.01 to 0.5, or 0.01 to 0.4, or 0.01 to 0.3, or 0.01 to 0.25, or 0.01 to 0.2, or 0.05 to 0.8, or 0.05 to 0.7, or 0.05 to 0.5, or 0.05 to 0.4, or 0.05 to 0.3, or 0.05 to 0.25, or 0.05 to 0.2, or 0.08 to 0.8, or 0.08 to 0.7, or 0.08 to 0.5, or 0.08 to 0.4, or 0.08 to 0.3, or 0.08 to 0.25, or 0.08 to 0.2, in weight percent of the total amount of secondary antioxidants based on the total weight of the composition. In one class of this embodiment, the stabilizer comprises a secondary antioxidant that is a phosphite compound. In one class of this embodiment, the stabilizer comprises a secondary antioxidant that is a phosphite compound and another secondary antioxidant that is DLTDP.

In one subclass of this class, the stabilizer further comprises a second stabilizer component that comprises one or more primary antioxidants in an amount in the range of from 0.05 to 0.7, or 0.05 to 0.6, or 0.05 to 0.5, or 0.05 to 0.4, or 0.05 to 0.3, or 0.1 to 0.6, or 0.1 to 0.5, or 0.1 to 0.4, or 0.1 to 0.3, in weight percent of the total amount of primary antioxidants based on the total weight of the composition. In one subclass of this class, the stabilizer further comprises a second stabilizer component that comprises citric acid in an amount in the range of from 0.05 to 0.2, or 0.05 to 0.15, or 0.05 to 0.1 in weight percent of the total amount of citric acid based on the total weight of the composition. In one subclass of this class, the stabilizer further comprises a second stabilizer component that comprises one or more primary antioxidants and citric acid in the amounts discussed herein. In one subclass of this class, the stabilizer comprises less than 0.1 wt % or no primary antioxidants, based on the total weight of the composition. In one subclass of this class, the stabilizer comprises less than 0.05 wt % or no primary antioxidants, based on the total weight of the composition.

In embodiments, depending on the application, e.g., single use food contact applications, the cellulose acetate composition may include at least one odor modifying additive. In embodiments, depending on the application and components used in the cellulose acetate composition, suitable odor modifying additives cellulose acetate be chosen from: vanillin, Pennyroyal M-1178, almond, cinnamyl, spices, spice extracts, volatile organic compounds or small molecules, and Plastidor. In one embodiment, the odor modifying additive cellulose acetate be vanillin. In embodiments, the cellulose acetate composition may include an odor modifying additive in an amount from 0.01 to 1 wt %, or 0.1 to 0.5 wt %, or 0.1 to 0.25 wt %, or 0.1 to 0.2 wt %, based on the total weight of the composition. Mechanisms for the odor modifying additives may include masking, capturing, complementing or combinations of these.

As discussed above, the cellulose acetate composition may include other optional additives. In embodiments, the cellulose acetate composition may include at least one compatibilizer. In embodiments, the compatibilizer may be either a non-reactive compatibilizer or a reactive compatibilizer. The compatibilizer may enhance the ability of the cellulose acetate or another component to reach a desired small particle size to improve the dispersion of the chosen component in the composition. In such embodiments, depending on the desired formulation, the biodegradable cellulose acetate may either be in the continuous or discontinuous phase of the dispersion. In embodiments, the compatibilizers used may improve mechanical and/or physical properties of the compositions by modifying the interfacial interaction/bonding between the biodegradable cellulose acetate and another component, e.g., other biodegradable polymer.

In embodiments, the cellulose acetate composition comprises a compatibilizer in an amount from about 1 to about 40 wt %, or about 1 to about 30 wt %, or about 1 to about 20 wt %, or about 1 to about 10 wt %, or about 5 to about 20 wt %, or about 5 to about 10 wt %, or about 10 to about 30 wt %, or about 10 to about 20 wt %, based on the weight of the cellulose acetate composition.

In embodiments, if desired, the cellulose acetate composition may include biodegradation and/or decomposition agents, e.g., hydrolysis assistant or any intentional degradation promoter additives may be added to or contained in the composition, added either during manufacture of the cellulose acetate or subsequent to its manufacture and melt or solvent blended together with the cellulose acetate to promote biodegradability of the cellulose acetate composition and/or disintegratability of an articles including or formed from it. In embodiments, additives may promote hydrolysis by releasing acidic or basic residues, and/or accelerate photo (UV) or oxidative degradation and/or promote the growth of selective microbial colony to aid the disintegration and biodegradation in compost and soil medium. In addition to promoting the degradation, these additives may have an additional function such as improving the processability of the article or improving desired mechanical properties.

One set of examples of possible decomposition agents include inorganic carbonate, synthetic carbonate, nepheline syenite, talc, magnesium hydroxide, aluminum hydroxide, diatomaceous earth, natural or synthetic silica, calcined clay, and the like. In embodiments, it may be desirable that these additives are dispersed well in the cellulose acetate composition matrix. The additives may be used singly, or in a combination of two or more.

Another set of examples of possible decomposition agents are aromatic ketones used as an oxidative decomposition agent, including benzophenone, anthraquinone, anthrone, acetylbenzophenone, 4-octylbenzophenone, and the like. These aromatic ketones may be used singly, or in a combination of two or more.

Other examples include transition metal compounds used as oxidative decomposition agents, such as salts of cobalt or magnesium, e.g., aliphatic carboxylic acid (C12 to C20) salts of cobalt or magnesium, or cobalt stearate, cobalt oleate, magnesium stearate, and magnesium oleate; or anatase-form titanium dioxide, or titanium dioxide may be used. Mixed phase titanium dioxide particles may be used in which both rutile and anatase crystalline structures are present in the same particle. The particles of photoactive agent may have a relatively high surface area, for example from about 10 to about 300 sq. m/g, or from 20 to 200 sq. m/g, as measured by the BET surface area method. The photoactive agent can be added to the plasticizer if desired. These transition metal compounds can be used singly, or in a combination of two or more.

Examples of rare earth compounds that may be used as oxidative decomposition agents include rare earths belonging to periodic table Group 3A, and oxides thereof. Specific examples thereof include cerium (Ce), yttrium (Y), neodymium (Nd), rare earth oxides, hydroxides, rare earth sulfates, rare earth nitrates, rare earth acetates, rare earth chlorides, rare earth carboxylates, and the like. More specific examples thereof include cerium oxide, ceric sulfate, ceric ammonium sulfate, ceric ammonium nitrate, cerium acetate, lanthanum nitrate, cerium chloride, cerium nitrate, cerium hydroxide, cerium octylate, lanthanum oxide, yttrium oxide, scandium oxide, and the like. These rare earth compounds may be used singly, or in a combination of two or more.

In one embodiment, the melt-processable cellulose acetate composition includes an additive with pro-degradant functionality to enhance biodegradability that comprises a transition metal salt or chemical catalyst, containing transition metals such as cobalt, manganese and iron. The transition metal salt comprises of tartrate, stearate, oleate, citrate and chloride. The additive further comprises of a free radical scavenging system and one or more inorganic or organic fillers such as chalk, talc, silica, wollastonite, starch, cotton, reclaimed cardboard and plant matter. The additive may also comprise an enzyme, a bacterial culture, a swelling agent, CMC, sugar or other energy sources. The additive may also comprise hydroxylamine esters and thio compounds.

In certain embodiments, other possible biodegradation and/or decomposition agents may include swelling agents and disintegrants. Swelling agents may be hydrophilic materials that increase in volume after absorbing water and exert pressure on the surrounding matrix. Disintegrants may be additives that promote the breakup of a matrix into smaller fragments in an aqueous environment. Examples include minerals and polymers, including crosslinked or modified polymers and swellable hydrogels. In embodiments, the composition may include water-swellable minerals or clays and their salts, such as laponite and bentonite; hydrophilic polymers, such as poly(acrylic acid) and salts, poly(acrylamide), poly(ethylene glycol) and poly(vinyl alcohol); polysaccharides and gums, such as starch, alginate, pectin, chitosan, psyllium, xanthan gum; guar gum, locust bean gum; and modified polymers, such as crosslinked PVP, sodium starch glycolate, carboxymethyl cellulose, gelatinized starch, croscarmellose sodium; or combinations of these additives.

In embodiments, the melt-processable cellulose acetate composition may include comprise a pH-basic additive that can increase decomposition or degradation of the composition or article made from (or comprising) the composition. Examples of pH-basic additives that may be used as oxidative decomposition agents include alkaline earth metal oxides, alkaline earth metal hydroxides, alkaline earth metal carbonates, alkali metal cellulose carbonates, alkali metal bicarbonates, ZnO and basic Al₂O₃. In embodiments, at least one basic additive may be MgO, Mg(OH)₂, MgCO₃, CaO, Ca(OH)₂, CaCO₃, NaHCO₃, Na₂CO₃, K₂CO₃, ZnO KHCO₃ or basic Al₂O₃. In one aspect, alkaline earth metal oxides, ZnO and basic Al₂O₃ may be used as a basic additive. In embodiments, combinations of different pH-basic additives, or pH-basic additives with other additives, may be used. In embodiments, the pH-basic additive has a pH in the range from greater than 7.0 to 10.0, or 7.1 to 9.5, or 7.1 to 9.0, or 7.1 to 8.5, or 7.1 to 8.0, measured in a 1 wt % mixture/solution of water.

Examples of organic acid additives that may be used as oxidative decomposition agents include acetic acid, propionic acid, butyric acid, valeric acid, citric acid, tartaric acid, oxalic acid, malic acid, benzoic acid, formate, acetate, propionate, butyrate, valerate citrate, tartarate, oxalate, malate, maleic acid, maleate, phthalic acid, phthalate, benzoate, and combinations thereof.

Examples of other hydrophilic polymers or biodegradation promoters may include glycols, polyglycols, polyethers, and polyalcohols or other biodegradable polymers such as poly(glycolic acid), poly(lactic acid), polyethylene glycol, polypropylene glycol, polydioxanes, polyoxalates, poly(α-esters), polycarbonates, polyanhydrides, polyacetals, polycaprolactones, poly(orthoesters), polyamino acids, aliphatic as polyesters such poly(butylene) succinate, poly(ethylene) succinate, starch, regenerated cellulose, or aliphatic-aromatic polyesters such as PBAT.

In embodiments, examples of colorants may include carbon black, iron oxides such as red or blue iron oxides, titanium dioxide, silicon dioxide, cadmium red, calcium carbonate, kaolin clay, aluminum hydroxide, barium sulfate, zinc oxide, aluminum oxide; and organic pigments such as azo and diazo and triazo pigments, condensed azo, azo lakes, naphthol pigments, anthrapyrimidine, benzimidazolone, carbazole, diketopyrrolopyrrole, flavanthrone, indigoid pigments, isoindolinone, isoindoline, isoviolanthrone, metal complex pigments, oxazine, perylene, perinone, pyranthrone, pyrazoloquinazolone, quinophthalone, triaryl carbonium pigments, triphendioxazine, xanthene, thioindigo, indanthrone, isoindanthrone, anthanthrone, anthraquinone, isodibenzanthrone, triphendioxazine, quinacridone and phthalocyanine series, especially copper phthalocyanme and its nuclear halogenated derivatives, and also lakes of acid, basic and mordant dyes, and isoindolinone pigments, as well as plant and vegetable dyes, and any other available colorant or dye.

In embodiments, luster control agents for adjusting the glossiness and fillers may include silica, talc, clay, barium sulfate, barium carbonate, calcium sulfate, calcium carbonate, magnesium carbonate, and the like.

Suitable flame retardants may include silica, metal oxides, phosphates, catechol phosphates, resorcinol phosphates, borates, inorganic hydrates, and aromatic polyhalides.

Although it is desirable for the cellulose acetate composition to be compostable and/or biodegradable, a certain amount of anti-fungal, antimicrobial or antibacterial agents may be added to provide a selected shelf life, useful service life or stability. Such agents include without limitation polyene antifungals (e.g., natamycin, rimocidin, filipin, nystatin, amphotericin B, cadicin, and hamycin), imidazole antifungals such as miconazole (available as MICATING from WellSpring Pharmaceutical Corporation), ketoconazole (commercially available as NIZORAL® from McNeil consumer Healthcare), clotrimazole (commercially available as LOTRAMIN® and LOTRAMIN AF® available from Merck and CASTEN® available from Bayer), econazole, omoconazole, bifonazole, butoconazole, fenticonazole, isoconazole, oxiconazole, sertaconazole (commercially available as ERTACZO® from OrthoDematologics), sulconazole, and tioconazole; triazole antifungals such as fluconazole, itraconazole, isavuconazole, ravuconazole, posaconazole, voriconazole, terconazole, and albaconazole), thiazole antifungals (e.g., abafungin), allylamine antifungals (e.g., terbinafine (commercially available as LAMISIL® from Novartis Consumer Health, Inc.), naftifine (commercially available as NAFTIN® available from Merz Pharmaceuticals), and butenafine (commercially available as LOTRAMIN ULTRA® from Merck), echinocadin antifungals (e.g., anidulafungin, capofungin, and micafungin), polygodial, benzoic acid, ciclopirox, tolnaftate (e.g., commercially available as TINACTIN® from MDS Consumer Care, Inc.), undecylenic acid, flucytosine, 5-fluorocytosine, griseofulvin, haloprogin, caprylic acid, and any combination thereof.

Viscosity modifiers having the purpose of modifying the melt flow index or viscosity of the biodegradable cellulose acetate composition that may be used include polyethylene glycols and polypropylene glycols, and glycerin.

In embodiments, other components that may be included in the composition may function as release agents or lubricants (e.g. fatty acids, ethylene glycol distearate), anti-block or slip agents (e.g. one or more fatty acid esters, metal stearate salts (for example, zinc stearate), and waxes), antifogging agents (e.g. surfactants), thermal stabilizers (e.g. epoxy stabilizers, derivatives of epoxidized soybean oil (ESBO), linseed oil, and sunflower oil), anti-static agents, foaming agents, biocides, impact modifiers, or reinforcing fibers. More than one component may be present in the composition. It should be noted that an additional component may serve more than one function in the composition. The different (or specific) functionality of any particular additive (or component) to the composition can be dependent on its physical properties (e.g., molecular weight, solubility, melt temperature, Tg, etc.) and/or the amount of such additive/component in the overall composition. For example, polyethylene glycol can function as a plasticizer at one molecular weight or as a hydrophilic agent (with little or no plasticizing effect) at another molecular weight.

In embodiments, fragrances may be added if desired. Examples of fragrances include spices, spice extracts, herb extracts, essential oils, smelling salts, volatile organic compounds, volatile small molecules, methyl formate, methyl acetate, methyl butyrate, ethyl acetate, ethyl butyrate, isoamyl acetate, pentyl butyrate, pentyl pentanoate, octyl acetate, myrcene, geraniol, nerol, citral, citronellal, citronellol, linalool, nerolidol, limonene, camphor, terpineol, alpha-ionone, thujone, benzaldehyde, eugenol, isoeugenol, cinnamaldehyde, ethyl maltol, vanilla, vanillin, cinnamyl alcohol, anisole, anethole, estragole, thymol, furaneol, methanol, rosemary, lavender, citrus, freesia, apricot blossoms, greens, peach, jasmine, rosewood, pine, thyme, oakmoss, musk, vetiver, myrrh, blackcurrant, bergamot, grapefruit, acacia, passiflora, sandalwood, tonka bean, mandarin, neroli, violet leaves, gardenia, red fruits, ylang-ylang, acacia farnesiana, mimosa, tonka bean, woods, ambergris, daffodil, hyacinth, narcissus, black currant bud, iris, raspberry, lily of the valley, sandalwood, vetiver, cedarwood, neroli, strawberry, carnation, oregano, honey, civet, heliotrope, caramel, coumarin, patchouli, dewberry, helonial, coriander, pimento berry, labdanum, cassie, aldehydes, orchid, amber, orris, tuberose, palmarosa, cinnamon, nutmeg, moss, styrax, pineapple, foxglove, tulip, wisteria, clematis, ambergris, gums, resins, civet, plum, castoreum, civet, myrrh, geranium, rose violet, jonquil, spicy carnation, galbanum, petitgrain, iris, honeysuckle, pepper, raspberry, benzoin, mango, coconut, hesperides, castoreum, osmanthus, mousse de chene, nectarine, mint, anise, cinnamon, orris, apricot, plumeria, marigold, rose otto, narcissus, tolu balsam, frankincense, amber, orange blossom, bourbon vetiver, opopanax, white musk, papaya, sugar candy, jackfruit, honeydew, lotus blossom, muguet, mulberry, absinthe, ginger, juniper berries, spicebush, peony, violet, lemon, lime, hibiscus, white rum, basil, lavender, balsamics, fo-ti-tieng, osmanthus, karo karunde, white orchid, calla lilies, white rose, rhubrum lily, tagetes, ambergris, ivy, grass, seringa, spearmint, clary sage, cottonwood, grapes, brimbelle, lotus, cyclamen, orchid, glycine, tiare flower, ginger lily, green osmanthus, passion flower, blue rose, bay rum, cassia, Africa tagetes, Anatolian rose, Auvergne narcissus, British broom, British broom chocolate, Bulgarian rose, Chinese patchouli, Chinese gardenia, Calabrian mandarin, Comoros Island tuberose, Ceylonese cardamom, Caribbean passion fruit, Damascena rose, Georgia peach, white Madonna lily, Egyptian jasmine, Egyptian marigold, Ethiopian civet, Farnesian cassie, Florentine iris, French jasmine, French jonquil, French hyacinth, Guinea oranges, Guyana capua, Grasse petitgrain, Grasse rose, Grasse tuberose, Haitian vetiver, Hawaiian pineapple, Israeli basil, Indian sandalwood, Indian Ocean vanilla, Italian bergamot, Italian iris, Jamaica pepper, May rose, Madagascar ylang-ylang, Madagascar vanilla, Moroccan jasmine, Moroccan rose, Moroccan oakmoss, Moroccan orange blossom, Mysore sandalwood, Oriental rose, Russian leather, Russian coriander, Sicilian mandarin, South African marigold, South America tonka bean, Singapore patchouli, Spanish orange blossom, Sicilian lime, Reunion Island vetiver, Turkish rose, Thai benzoin, Tunisian orange blossom, Yugoslavian oakmoss, Virginian cedarwood, Utah yarrow, West Indian rosewood, and the like, and any combination thereof.

As described herein, the cellulose acetate composition of the present invention is melt-processable and may be useful in forming melt-formed articles. Accordingly, in another aspect, the present invention is directed to a melt-processable, biodegradable cellulose acetate melt. The term “melt” is utilized to generally describe a flowable, liquid form of the composition, sometimes viscous in nature, typically created by raising the composition to a temperature sufficient to facilitate molten flow (in contrast for example to addition of a solvent to form a dispersion, suspension or solution). A melt is typically the form necessary for melt-processing to produce a melt-formed article. In describing a composition herein as “melt-processable”, is intended to include compositions which are capable of forming a melt that is processable into useful melt-formed articles using melt processes such as extrusion, including without limitation profile extrusion and sheet extrusion; injection molding; compression molding; blow molding; thermoforming; and the like. Accordingly, in one or more embodiments, the present invention is directed to a cellulose acetate melt, useful in particular for forming melt-formed articles. In one or more embodiments, the cellulose acetate melt includes, is prepared from or is formed from the melt-processable cellulose acetate composition of the present invention. In one or more embodiments, the cellulose acetate melt includes (i) cellulose acetate; (ii) fatty acid; and (iii) an optional processing aid.

An important general feature of the melt-processable compositions and melts of the present invention is the unexpected improvement in processability in the manufacture of melt-formed articles. One parameter that demonstrates this feature may be melt viscosity. Melt viscosity measures the rate of extrusion of thermoplastics through an orifice at a prescribed temperature and load and is an important indicator of equipment power consumption, torque and pressure during melt processing. Melt viscosity provides a means of measuring flow of a melted material which can be used to evaluate the consistency and processibility of materials. Representative methods to evaluate processability include melt flow rate (MFR), melt volume-flow rate (MVR), a method using a measuring instrument such as a capillary rheometer, melt rheology, melt flow index (MFI; described in standards ASTM D1238 and ISO1133, bar flow evaluation using an injection molding machine. Viscosity is measured according to ASTM D-4440. Formulations described in this invention have a melt viscosity between 3000 poise to as much as 500,000 poise when measured at 230 C and a shear rate of 1 rad/sec. Processing temperatures can be altered to yield desired flow behavior based on the target application.

Differential Scanning calorimetry (DSC) was completed using a TA Instruments Q2000 device which determines thermal transitions of the polymer. The glass transition temperature (Tg), melting point (Tm) values and crystallization behavior of the polymer blends were determined. In addition, miscible mixes can be determined by the observation of a single Tg that is correlated to the ratios of the items mixed. To analyze the samples, (4 to 8 mg) of each sample was sealed in aluminum DSC pans and evaluated using a heat-cool-heat method. For the 1st heat, the samples were evaluated from 23° C. to 250° C. at a scan rate of 20° C. per minute and transitions were marked. Next the sample was cooled from 250° C. to 23° C. at a scan rate of 20° C. per minute and transitions were marked. Finally, the samples were reheated a second time (second heat method) from 23° C. to 250° C. at a scan rate of 20° C. per minute and the transitions were marked. The Tg was determined during the 2nd heat to minimize the impact of moisture on the sample results. Transitions are marked and recorded in accordance with ASTM D3418.

In one or more embodiments, the melt-processable biodegradable cellulose acetate composition of the present invention is a foamable composition. In one or more embodiments, the melt processable, biodegradable, foamable composition of the present invention includes (i) cellulose acetate; (ii) fatty acid; (iii) optionally, a processing aid; (iv) optionally, at least one nucleating agent; and (v) at least one blowing agent selected from the group consisting of a physical blowing agent, a chemical blowing composition comprising a chemical blowing agent and carrier polymer and combinations thereof.

In another aspect, the present invention is directed to an article. In one or more embodiments, the article is a melt-formed article. The article of the present invention includes, is formed from or is prepared using a melt-processable composition that includes cellulose acetate, fatty acid and optionally a processing aid. In one or more embodiments, the articles may be extruded articles such as profile extruded articles and sheet extruded articles; injection molded articles; compression molded articles; thermoformed articles; and the like. In one or more embodiments, the melt-formed articles of the present invention may be molded single use food contact articles, including articles that are biodegradable and/or compostable (i.e., either industrial or home compostability tests/criterial as discussed herein). In embodiments, the cellulose acetate compositions may be extrudable, moldable, castable, thermoformable, or may be 3-D printed. “Articles” as used herein is defined to include articles in their entirety as well as components, elements or parts of articles that may be connected, adhered, assembled or the like. In embodiments, the articles are environmentally non-persistent. “Environmentally non-persistent” is meant to describe materials or articles that, upon reaching an advanced level of disintegration, become amenable to total consumption by the natural microbial population. The degradation of biodegradable cellulose acetate ultimately leads its conversion to carbon dioxide, water and biomass.

In embodiments, articles comprising the cellulose acetate compositions (discussed herein) are provided that have a maximum thickness up to 150 mils, or 140 mils, or 130 mils, or 120 mils, or 110 mils, or 100 mils, or 90 mils, or 80 mils, or 70 mils, or 60 mils, or 50 mils, or 40 mils, or 30 mils, or 25 mils, or 20 mils, or 15 mils, or 10 mils, and may be biodegradable and/or compostable. In embodiments, articles comprising the cellulose acetate compositions (discussed herein) are provided that have a maximum thickness up to 150 mils, or 140 mils, or 130 mils, or 120 mils, or 110 mils, to 100 mils, or 90 mils, or 80 mils, or 70 mils, or 60 mils, or 50 mils, or 40 mils, or 30 mils, or 25 mils, or 20 mils, or 15 mils, or 10 mils, and may be environmentally non-persistent.

In embodiments, the melt-processable biodegradable cellulose acetate composition of the present invention, as well as the melt and the melt-formed article, may include recycle content. In one or more embodiments, the recycle content includes biodegradable cellulose acetate regrind. The term “regrind” is intended to include material sourced from reclaimed, scrap, in-house scrap such as scrap from molders, off-spec or post-industrial sources that has been ground, milled, crushed, pulverized or the like to a particle- or powder-like form.

In one or more embodiments, the recycle content is provided by a reactant derived from recycled material that is the source of one or more acetyl groups on a recycle cellulose acetate. In embodiments, the reactant is derived from recycled plastic. In embodiments, the reactant is derived from recycled plastic content syngas. By “recycled plastic content syngas” is meant syngas obtained from a synthesis gas operation utilizing a feedstock that contains at least some content of recycled plastics, as described in the various embodiments more fully herein below. In embodiments, the recycled plastic content syngas can be made in accordance with any of the processes for producing syngas described herein; can comprise, or consist of, any of the syngas compositions or syngas composition streams described herein; or can be made from any of the feedstock compositions described herein.

In embodiments, the feedstock (for the synthesis gas operation) may be in the form of a combination of one or more particulated fossil fuel sources and particulated recycled plastics. In one embodiment or in any of the mentioned embodiments, the solid fossil fuel source may include coal. In embodiments, the feedstock is fed to a gasifier along with an oxidizer gas, and the feedstock is converted to syngas.

In embodiments, the recycled plastic content syngas is utilized to make at least one chemical intermediate in a reaction scheme to make a recycle cellulose acetate. In embodiments, the recycled plastic content syngas may be a component of feedstock (used to make at least one cellulose acetate intermediate or reactant that includes other sources of syngas, hydrogen, carbon monoxide, or combinations thereof. In one embodiment or in any of the mentioned embodiments, the only source of syngas used to make the cellulose acetate intermediates is the recycled plastic content syngas.

In embodiments, the cellulose acetate intermediates made using the recycled content syngas, e.g., recycled plastic content syngas, may be chosen from methanol, acetic acid, methyl acetate, acetic anhydride and combinations thereof. In embodiments, the cellulose acetate intermediates may be at least one reactant or at least one product in one or more of the following reactions: (1) syngas conversion to methanol; (2) syngas conversion to acetic acid; (3) methanol conversion to acetic acid, e.g., carbonylation of methanol to produce acetic acid; (4) producing methyl acetate from methanol and acetic acid; and (5) conversion of methyl acetate to acetic anhydride, e.g., carbonylation of methyl acetate and methanol to acetic acid and acetic anhydride.

In embodiments, recycled plastic content syngas is used to produce at least one cellulose reactant. In embodiments, the recycled plastic content syngas is used to produce at least one recycle cellulose acetate.

In embodiments, the recycled plastic content syngas is utilized to make acetic anhydride. In embodiments, syngas that comprises recycled plastic content syngas is first converted to methanol and this methanol is then used in a reaction scheme to make acetic anhydride. “RPS acetic anhydride” refers to acetic anhydride that is derived from recycled plastic content syngas. Derived from means that at least some of the feedstock source material (that is used in any reaction scheme to make a cellulose acetate intermediate) has some content of recycled plastic content syngas.

In embodiments, the RPS acetic anhydride is utilized as a cellulose acetate intermediate reactant for the esterification of cellulose to prepare a recycle cellulose acetate, as discussed more fully above. In embodiments, the RPS acetic acid is utilized as a reactant to prepare cellulose acetate or cellulose diacetate.

In embodiments, the recycle cellulose acetate prepared from a cellulose reactant that comprises acetic anhydride that is derived from recycled plastic content syngas.

In embodiments, the recycled plastic content syngas comprises gasification products from a gasification feedstock. In an embodiment, the gasification products are produced by a gasification process using a gasification feedstock that comprises recycled plastics. In embodiments, the gasification feedstock comprises coal.

In embodiments, the gasification feedstock comprises a liquid slurry that comprises coal and recycled plastics. In embodiments, the gasification process comprises gasifying said gasification feedstock in the presence of oxygen.

In one or more embodiments, the melt-processable cellulose acetate composition includes at least one cellulose ester having at least one substituent on an anhydroglucose unit (AGU) derived from one or more chemical intermediates, at least one of which is obtained at least in part from recycled plastic content syngas.

In embodiments, the cellulose acetate of the melt-processable cellulose acetate composition includes cellulose acetate derived from a renewable source, e.g., cellulose from wood or cotton linter, and cellulose acetate derived from a recycled material source, e.g., recycled plastics or recycle syn-gas. Thus, in embodiments, a melt processible cellulose acetate composition is provided that is biodegradable and contains both renewable and recycled content, i.e., made from renewable and recycled sources.

In embodiments, the composition and the article of the present invention may have a certain degree of degradation. The degree of degradation may be characterized by the weight loss of a sample over a given period of exposure to certain environmental conditions. In some cellulose acetates, the cellulose acetate exhibits a weight loss of at least about 5, 10, 15, or 20 percent after burial in soil for 60 days and/or a weight loss of at least about 15, 20, 25, 30, or 35 percent after 15 days of exposure to a typical municipal composter. However, the rate of degradation may vary depending on the particular end use. Exemplary degree of degradation test conditions are provided in U.S. Pat. Nos. 5,970,988 and 6,571,802, the contents and disclosure of which are hereby incorporated herein by reference.

In some embodiments, the cellulose acetate composition may be in the form of biodegradable single use (formed/molded) articles. It has been found that melt-processable cellulose acetate compositions as described herein may exhibit enhanced levels of environmental non-persistence, characterized by better-than-expected degradation under various environmental conditions. Melt-formed articles described herein may meet or exceed one or more passing standards set by international test methods and authorities for industrial compostability, home compostability, marine biodegradability and/or soil biodegradability.

To be considered “compostable,” a material must meet the following four criteria: (1) the material should pass biodegradation requirement in a test under controlled composting conditions at elevated temperature (58° C.) according to ISO 14855-1 (2012) which correspond to an absolute 90% biodegradation or a relative 90% to a control polymer, (2) the material tested under aerobic composting condition according to ISO16929 (2013) must reach a 90% disintegration; (3) the test material must fulfill all the requirements on volatile solids, heavy metals and fluorine as stipulated by ASTM D6400 (2012), EN 13432 (2000) and ISO 17088 (2012); and (4) the material should not negatively impact plant growth. As used herein, the term “biodegradable” generally refers to the biological conversion and consumption of organic molecules. Biodegradability is an intrinsic property of the material itself, and the material can exhibit different degrees of biodegradability, depending on the specific conditions to which it is exposed. The term “disintegrable” refers to the tendency of a material to physically decompose into smaller fragments when exposed to certain conditions. Disintegration depends both on the material itself, as well as the physical size and configuration of the article being tested. Ecotoxicity measures the impact of the material on plant life, and the heavy metal content of the material is determined according to the procedures laid out in the standard test method.

In one or more embodiments, the compositions of the present invention may be biodegradable. In one or more embodiments, the melts of the present invention may be biodegradable.

The melt-processable cellulose acetate composition (or article comprising same) may exhibit a biodegradation of at least 70 percent in a period of not more than 50 days, when tested under aerobic composting conditions at ambient temperature (28° C.±2° C.) according to ISO 14855-1 (2012). In some cases, the (or article including or formed therefrom) may exhibit a biodegradation of at least 70 percent in a period of not more than 49, 48, 47, 46, 45, 44, 43, 42, 41, 40, 39, 38, or 37 days when tested under these conditions, also called “home composting conditions.” These conditions may not be aqueous or anaerobic. In some cellulose acetates, the cellulose acetate composition (or article comprising same) may exhibit a total biodegradation of at least about 71, 72, 73, 74, 75, 76, 77, 78, 79, 80, 81, 82, 83, 84, 85, 86, 87, or 88 percent, when tested under according to ISO 14855-1 (2012) for a period of 50 days under home composting conditions. This may represent a relative biodegradation of at least about 95, 97, 99, 100, 101, 102, or 103 percent, when compared to cellulose subjected to identical test conditions.

To be considered “biodegradable,” under home composting conditions according to the French norm NF T 51-800 and the Australian standard AS 5810, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradation under home compositing conditions is 1 year. The cellulose acetate composition as described herein may exhibit a biodegradation of at least 90 percent within not more than 1 year, measured according 14855-1 (2012) under home composting conditions. In some cellulose acetates, the cellulose acetate composition (or article comprising same) may exhibit a biodegradation of at least about 91, 92, 93, 94, 95, 96, 97, 98, 99, or 99.5 percent within not more than 1 year, or cellulose acetate composition (or article comprising same) may exhibit 100 percent biodegradation within not more than 1 year, measured according 14855-1 (2012) under home composting conditions.

Additionally, or in the alternative, the cellulose acetate composition (or article comprising same) described herein may exhibit a biodegradation of at least 90 percent within not more than about 350, 325, 300, 275, 250, 225, 220, 210, 200, 190, 180, 170, 160, 150, 140, 130, 120, 110, 100, 90, 80, 70, 60, or 50 days, measured according 14855-1 (2012) under home composting conditions. In some embodiments, the composition (or article comprising same) may be at least about 97, 98, 99, or 99.5 percent biodegradable within not more than about 70, 65, 60, or 50 days of testing according to ISO 14855-1 (2012) under home composting conditions. As a result, the composition (or article including or formed therefrom) may be considered biodegradable according to, for example, French Standard NF T 51-800 and Australian Standard AS 5810 when tested under home composting conditions.

The composition (or article comprising same) may exhibit a biodegradation of at least 60 percent in a period of not more than 45 days, when tested under aerobic composting conditions at a temperature of 58° C. (+2° C.) according to ISO 14855-1 (2012). In some cases, the cellulose acetate composition (or article comprising same) may exhibit a biodegradation of at least 60 percent in a period of not more than 44, 43, 42, 41, 40, 39, 38, 37, 36, 35, 34, 33, 32, 31, 30, 29, 28, or 27 days when tested under these conditions, also called “industrial composting conditions.” These may not be aqueous or anaerobic conditions. In some cases, the cellulose acetate composition (or article comprising same) may exhibit a total biodegradation of at least about 65, 70, 75, 80, 85, 87, 88, 89, 90, 91, 92, 93, 94, or 95 percent, when tested under according to ISO 14855-1 (2012) for a period of 45 days under industrial composting conditions. This may represent a relative biodegradation of at least about 95, 97, 99, 100, 102, 105, 107, 110, 112, 115, 117, or 119 percent, when compared to the same cellulose acetate composition (or article comprising same) subjected to identical test conditions.

To be considered “biodegradable,” under industrial composting conditions according to ASTM D6400 and ISO 17088, at least 90 percent of the organic carbon in the whole item (or for each constituent present in an amount of more than 1% by dry mass) must be converted to carbon dioxide by the end of the test period when compared to the control or in absolute. According to European standard ED 13432 (2000), a material must exhibit a biodegradation of at least 90 percent in total, or a biodegradation of at least 90 percent of the maximum degradation of a suitable reference material after a plateau has been reached for both the reference and test item. The maximum test duration for biodegradability under industrial compositing conditions is 180 days. The cellulose acetate composition (or article comprising same) described herein may exhibit a biodegradation of at least 90 percent within not more than 180 days, measured according 14855-1 (2012) under industrial composting conditions. In some cases, the cellulose acetate composition (or article comprising same) may exhibit a biodegradation of at least about 91, 92, 93, 94, 95, 96, 97, 98, 99, or 99.5 percent within not more than 180 days, or cellulose acetate composition (or article comprising same) may exhibit 100 percent biodegradation within not more than 180 days, measured according 14855-1 (2012) under industrial composting conditions.

Additionally, or in the alternative, cellulose acetate composition (or article comprising same) described herein may exhibit a biodegradation of least 90 percent within not more than about 175, 170, 165, 160, 155, 150, 145, 140, 135, 130, 125, 120, 115, 110, 105, 100, 95, 90, 85, 80, 75, 70, 65, 60, 55, 50, or 45 days, measured according 14855-1 (2012) under industrial composting conditions. In some cases, the CELLULOSE ACETATE composition (or article comprising same) may be at least about 97, 98, 99, or 99.5 percent biodegradable within not more than about 65, 60, 55, 50, or 45 days of testing according to ISO 14855-1 (2012) under industrial composting conditions. As a result, the cellulose acetate composition (or article comprising same) described herein may be considered biodegradable according to ASTM D6400 and ISO 17088 when tested under industrial composting conditions.

The cellulose acetate composition (or article comprising same) may exhibit a biodegradation in soil of at least 60 percent within not more than 130 days, measured according to ISO 17556 (2012) under aerobic conditions at ambient temperature. In some cases, the composition (or article comprising same) may exhibit a biodegradation of at least 60 percent in a period of not more than 130, 120, 110, 100, 90, 80, or 75 days when tested under these conditions, also called “soil composting conditions.” These may not be aqueous or anaerobic conditions. In some cases, the composition (or article comprising same) may exhibit a total biodegradation of at least about 65, 70, 72, 75, 77, 80, 82, or 85 percent, when tested under according to ISO 17556 (2012) for a period of 195 days under soil composting conditions. This may represent a relative biodegradation of at least about 70, 75, 80, 85, 90, or 95 percent, when compared to the same composition (or article comprising same) subjected to identical test conditions.

In order to be considered “biodegradable,” under soil composting conditions according the OK biodegradable SOIL conformity mark of Vinçotte and the DIN Geprüft Biodegradable in soil certification scheme of DIN CERTCO, a material must exhibit a biodegradation of at least 90 percent in total (e.g., as compared to the initial sample), or a biodegradation of at least 90 percent of the maximum degradation of a suitable reference material after a plateau has been reached for both the reference and test item. The maximum test duration for biodegradability under soil compositing conditions is 2 years. The composition (or article including or formed therefrom) as described herein may exhibit a biodegradation of at least 90 percent within not more than 2 years, 1.75 years, 1 year, 9 months, or 6 months measured according to ISO 17556 (2012) under soil composting conditions. In some cases, the composition (or article comprising same) may exhibit a biodegradation of at least about 91, 92, 93, 94, 95, 96, 97, 98, 99, or 99.5 percent within not more than 2 years, or composition (or article comprising same) may exhibit 100 percent biodegradation within not more than 2 years, measured according to ISO 17556 (2012) under soil composting conditions.

Additionally, or in the alternative, the composition (or article comprising same) described herein may exhibit a biodegradation of at least 90 percent within not more than about 700, 650, 600, 550, 500, 450, 400, 350, 300, 275, 250, 240, 230, 220, 210, 200, or 195 days, measured according 17556 (2012) under soil composting conditions. In some cases, the composition (or article comprising same) may be at least about 97, 98, 99, or 99.5 percent biodegradable within not more than about 225, 220, 215, 210, 205, 200, or 195 days of testing according to ISO 17556 (2012) under soil composting conditions. As a result, the composition (or article comprising same) described herein may meet the requirements to receive the OK biodegradable SOIL conformity mark of Vinçotte and to meet the standards of the DIN Geprüft Biodegradable in soil certification scheme of DIN CERTCO.

In some embodiments, composition (or article comprising same) of the present invention may include less than 1, 0.75, 0.50, or 0.25 weight percent of components of unknown biodegradability. In some cases, the composition (or article comprising same) described herein may include no components of unknown biodegradability.

In addition to being biodegradable under industrial and/or home composting conditions, composition (or article comprising same) as described herein may also be compostable under home and/or industrial conditions. As described previously, a material is considered compostable if it meets or exceeds the requirements set forth in EN 13432 for biodegradability, ability to disintegrate, heavy metal content, and ecotoxicity. The composition (or article comprising same) described herein may exhibit sufficient compostability under home and/or industrial composting conditions to meet the requirements to receive the OK compost and OK compost HOME conformity marks from Vinçotte.

In some cases, the composition (or article comprising same) described herein may have a volatile solids concentration, heavy metals and fluorine content that fulfill all of the requirements laid out by EN 13432 (2000). Additionally, the composition (or article comprising same) may not cause a negative effect on compost quality (including chemical parameters and ecotoxicity tests).

In some cases, the composition (or article comprising same) may exhibit a disintegration of at least 90 percent within not more than 26 weeks, measured according to ISO 16929 (2013) or according to ISO 20200 for a period of 12 weeks under industrial compositing conditions under industrial composting conditions. In some cases, the composition (or article comprising same) may exhibit a disintegration of at least about 91, 92, 93, 94, 95, 96, 97, 98, 99, or 99.5 percent under industrial composting conditions within not more than 26 weeks, or composition (or article comprising same) may be 100 percent disintegrated under industrial composting conditions within not more than 26 weeks. Alternatively, or in addition, the composition (or article comprising same) may exhibit a disintegration of at least 90 percent under industrial compositing conditions within not more than about 26, 25, 24, 23, 22, 21, 20, 19, 18, 17, 16, 15, 14, 13, 12, 11, or 10 weeks, measured according to ISO 16929 (2013) or ISO 20200. In some cases, the composition (or article comprising same) described herein may be at least 97, 98, 99, or 99.5 percent disintegrated within not more than 12, 11, 10, 9, or 8 weeks under industrial composting conditions, measured according to ISO 16929 (2013) or ISO 20200.

In some embodiments, the composition (or article comprising same) may exhibit a disintegration of at least 90 percent within not more than 26 weeks, measured according to ISO 16929 (2013) under home composting conditions. In some cases, the composition (or article comprising same) may exhibit a disintegration of at least about 91, 92, 93, 94, 95, 96, 97, 98, 99, or 99.5 percent under home composting conditions within not more than 26 weeks, or the composition (or article comprising same) may be 100 percent disintegrated under home composting conditions within not more than 26 weeks.

Alternatively, or in addition, the composition (or article comprising same) may exhibit a disintegration of at least 90 percent within not more than about 26, 25, 24, 23, 22, 21, 20, 19, 18, 17, 16, or 15 weeks under home composting conditions, measured according to ISO 16929 (2013). In some embodiments, the composition (or article comprising same) described herein may be at least 97, 98, 99, or 99.5 percent disintegrated within not more than 20, 19, 18, 17, 16, 15, 14, 13, or 12 weeks, measured under home composting conditions according to ISO 16929 (2013).

In embodiments or in combination with any other embodiments, when the composition is formed into a film having a thickness of 0.13, or 0.25. or 0.38, or 0.51, or 0.64, or 0.76, or 0.89, or 1.02, or 1.14, or 1.27, or 1.40, or 1.52 mm, the film exhibits greater than 90% disintegration after 12 weeks according to Disintegration Test Protocol, as described in the specification or in the alternative according to ISO 16929 (2013). In certain embodiments, when the composition is formed into a film having a thickness of 0.76, or 0.89, or 1.02, or 1.14, or 1.27, or 1.40, or 1.52 mm, the film exhibits greater than 90% disintegration after 12 weeks according to Disintegration Test Protocol, as described in the specification or in the alternative according to ISO 16929 (2013). In certain embodiments, when the composition is formed into a film having a thickness of 0.13, or 0.25. or 0.38, or 0.51, or 0.64, or 0.76, or 0.89, or 1.02, or 1.14, or 1.27, or 1.40, or 1.52 mm, the film exhibits greater than 90, or 95, or 96, or 97, or 98, or 99% disintegration after 12 weeks according to Disintegration Test Protocol, as described in the specification or in the alternative according to ISO 16929 (2013). In certain embodiments, when the composition is formed into a film having a thickness of 0.13, or 0.25. or 0.38, or 0.51, or 0.64, or 0.76, or 0.89, or 1.02, or 1.14, or 1.27, or 1.40, or 1.52 mm, the film exhibits greater than 90, or 95, or 96, or 97, or 98, or 99% disintegration after 8, or 9, or 10, or 11, or 12, or 13, or 14, or 15, or 16 weeks according to Disintegration Test Protocol, as described in the specification or in the alternative according to ISO 16929 (2013).

In some embodiments, the composition (or article comprising same) described herein may be substantially free of photodegradation agents. For example, the composition (or article comprising same) may include not more than about 1, 0.75, 0.50, 0.25, 0.10, 0.05, 0.025, 0.01, 0.005, 0.0025, or 0.001 weight percent of photodegradation agent, based on the total weight of the composition (or article comprising same), or the composition (or article comprising same) may include no photodegradation agents. Examples of such photodegradation agents include, but are not limited to, pigments which act as photooxidation catalysts and are optionally augmented by the presence of one or more metal salts, oxidizable promoters, and combinations thereof. Pigments may include coated or uncoated anatase or rutile titanium dioxide, which may be present alone or in combination with one or more of the augmenting components such as, for example, various types of metals. Other examples of photodegradation agents include benzoins, benzoin alkyl ethers, benzophenone and its derivatives, acetophenone and its derivatives, quinones, thioxanthones, phthalocyanine and other photosensitizers, ethylene-carbon monoxide copolymer, aromatic ketone-metal salt sensitizers, and combinations thereof.

In an aspect, biodegradable and/or compostable articles are provided that comprise the compositions, as described herein. In embodiments, the articles are made from moldable thermoplastic material comprising the compositions, as described herein.

In embodiments, the articles are single use food contact articles. Examples of such articles that may be made with the compositions include cups, trays, multi-compartment trays, clamshell packaging, films, sheets, trays and lids (e.g., thermoformed), candy sticks, stirrers, straws, plates, bowls, portion cups, food packaging, liquid carrying containers, solid or gel carrying containers, and cutlery. In embodiments, the articles may be horticultural articles. Examples of such articles that may be made with the compositions include plant pots, plant tags, mulch films, and agricultural ground cover.

In another aspect, a composition is provided that comprises recycle cellulose acetate prepared by an integrated process which comprises the processing steps of: (1) preparing a recycled plastic content syngas in a synthesis gas operation utilizing a feedstock that contains a solid fossil fuel source and at least some content of recycled plastics; (2) preparing at least one chemical intermediate from said syngas; (3) reacting said chemical intermediate in a reaction scheme to prepare at least one cellulose reactant for preparing a recycle cellulose acetate, and/or selecting said chemical intermediate to be at least one cellulose reactant for preparing a recycle cellulose acetate; and (4) reacting said at least one cellulose reactant to prepare said recycle cellulose acetate; wherein said recycle cellulose acetate comprises at least one substituent on an anhydroglucose unit (AGU) derived from recycled plastic content syngas.

In embodiments, the processing steps (1) to (4) are carried out in a system that is in fluid and/or gaseous communication (i.e., including the possibility of a combination of fluid and gaseous communication. It should be understood that the chemical intermediates, in one or more of the reaction schemes for producing recycle cellulose acetates starting from recycled plastic content syngas, may be temporarily stored in storage vessels and later reintroduced to the integrated process system.

In embodiments, the at least one chemical intermediate is chosen from methanol, methyl acetate, acetic anhydride, acetic acid, or combinations thereof. In embodiments, one chemical intermediate is methanol, and the methanol is used in a reaction scheme to make a second chemical intermediate that is acetic anhydride. In embodiments, the cellulose reactant is acetic anhydride.

In embodiments, the melt-processable, biodegradable cellulose acetate composition comprises cellulose acetate (as described herein), a plasticizer composition and a stabilizer composition, wherein the plasticizer composition comprises one or more food grade plasticizers and is present in an amount from 5% to 30% or 5% to 25% or 5% to 20% or 5% to 17% or 5% to 15% or 5% to 10% wt %, based on the total weight of the cellulose ester composition. When present, the optional stabilizer composition comprises one or more secondary antioxidants and is present in an amount from 0.08 to 0.8, or 0.08 to 0.7, or 0.08 to 0.6 wt %, based on the total weight of the cellulose ester composition.

In embodiments, the plasticizer composition comprises triacetin in an amount from 5 to 20 wt %, based on the total weight of the cellulose ester composition; and the optional stabilizer composition comprises one or more secondary antioxidants in an amount from 0.1 to 0.4, or 0.1 to 0.3 wt % and one or more primary antioxidants in an amount from 0.1 to 0.4, or 0.2 to 0.4 wt %, where wt % is based on the total weight of the cellulose ester composition. In one class of this embodiment, the one or more secondary antioxidants comprises a phosphite compound (e.g., Weston 705T or Doverphos S-9228T), DLTDP or a combination thereof and the one or more primary antioxidants comprises Irganox 1010, BHT or a combination thereof. In embodiments, the cellulose ester composition has a b* less than 40, or less than 35, or less than 30, or less than 25, or less than 20, or less than 15 after normal cycle time during injection molding (as described in the examples); or has a b* less than 40, or less than 35, or less than 30, or less than 25, or less than 20 after doubling the cycle time during injection molding (as described in the examples).

In embodiments, the plasticizer composition comprises polyethylene glycol an average molecular weight of from 300 to 500 Daltons in an amount from 5% to 20% by weight, based on the total weight of the cellulose ester composition; and the optional stabilizer composition comprises one or more secondary antioxidants in an amount from 0.01 to 0.8, or 0.1 to 0.5, or 0.1 to 0.3, or 0.1 to 0.2 wt %, based on the total weight of the cellulose ester composition. In one class of this embodiment, the one or more secondary antioxidants comprises a phosphite compound (e.g., Weston 705T or Doverphos S-9228T), DLTDP or a combination thereof. In another class of this embodiment, the stabilizer composition further comprises one or more primary antioxidants (e.g., Irganox 1010 or BHT), citric acid or a combination thereof, wherein the one or more primary antioxidants are present in an amount from 0.1 to 0.5, or 0.1 to 0.4 wt %, based on the total weight of the cellulose acetate composition, and wherein the citric acid is present in an amount from 0.05 to 0.2, or 0.05 to 0.15 wt %, based on the total weight of the cellulose acetate composition.

In embodiments, the plasticizer composition comprises polyethylene glycol an average molecular weight of from 300 to 500 Daltons in an amount from 5% to 20% or 5% to 17% or 5% to 16% or 5% to 15% by weight, based on the total weight of the cellulose ester composition; and the optional stabilizer composition comprises one or more secondary antioxidants in an amount from 0.1 to 0.5, or 0.1 to 0.3, or 0.1 to 0.2 wt %, based on the total weight of the cellulose ester composition.

The present application also discloses a composition comprising: (1) a cellulose acetate, wherein the cellulose acetate has an acetyl degree of substitution (“DSAc”) in the range of from 2.2 to 2.6, (2) from 5 to 20 wt % of a polyethylene glycol or a methoxy polyethylene glycol composition having an average molecular weight of from 300 Daltons to 550 Daltons, and (3) a fatty acid, wherein the composition is melt processable and biodegradable and an article prepared using or formed from is biodegradable.

In one embodiment or in combination with any other embodiment, the composition comprises polyethylene glycol having an average molecular weight of from 300 to 500 Daltons.

In one embodiment or in combination with any other embodiment, the composition comprises polyethylene glycol having an average molecular weight of from 350 to 550 Daltons.

In one embodiment or in combination with any other embodiment, the cellulose acetate has a number average molecular weight (“Mn”) in the range of from 10,000 to 90,000 Daltons, as measured by GPC. In one embodiment or in combination with any other embodiment, the cellulose acetate has a number average molecular weight (“Mn”) in the range of from 30,000 to 90,000 Daltons, as measured by GPC. In one embodiment or in combination with any other embodiment, the cellulose acetate has a number average molecular weight (“Mn”) in the range of from 40,000 to 90,000 Daltons, as measured by GPC.

In one embodiment or in combination with any other embodiment, wherein when the composition is formed into a film having a thickness of 0.38 mm, the film exhibits greater than 5% disintegration after 6 weeks and greater than 90% disintegration after 12 weeks according to the Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 10% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 20% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 30% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 50% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 70% disintegration after 6 weeks and greater than 90% disintegration after 12 weeks according to Disintegration Test Protocol, as described in the specification or in the alternative according to ISO 16929 (2013).

In one embodiment or in combination with any other embodiment, when the composition is formed into a film having a thickness of 0.76 mm, the film exhibits greater than 30% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 50% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 70% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 90% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 95% disintegration after 12 weeks according to Disintegration Test protocol, as described in the specification or in the alternative according to ISO 16929 (2013).

In one embodiment or in combination with any other embodiment, the composition further comprises at least one additional component chosen from a filler, an additive, a biopolymer, a stabilizer, or an odor modifier.

In one embodiment or in combination with any other embodiment, the composition further comprises a filler in an amount of from 1 to 60 wt %, based on the total weight of the composition. In one class of this embodiment, the filler is a carbohydrate, a cellulosic filler, an inorganic filler, a food byproduct, a desiccant, an alkaline filler, or combinations thereof.

In one subclass of this class, the filler is an inorganic filler. In one sub-subclass of this subclass, the inorganic filer is calcium carbonate.

In one subclass of this class, the filler is a carbohydrate. In one subclass of this class, the filler is a cellulosic filler. In one subclass of this class, the filler is a food byproduct. In one subclass of this class, the filler is a desiccant. In one subclass of this class, the filler is an alkaline filler.

In one embodiment or in combination with any other embodiment, the composition further comprises an odor modifying additive in an amount of from 0.001 to 1 wt %, based on the total weight of the composition. In one class of this embodiment, the odor modifying additive is vanillin, Pennyroyal M-1178, almond, cinnamyl, spices, spice extracts, volatile organic compounds or small molecules, or Plastidor. In one subclass of this class, the odor modifying additive is vanillin.

In one embodiment or in combination with any other embodiment, the composition further comprises a stabilizer in an amount from 0.01 to 5 wt %, based on the total composition. In one class of this embodiment, the stabilizer is a UV absorber, an antioxidant (e.g., ascorbic acid, BHT, BHA, etc), an acid scavenger, a radical scavenger, an epoxidized oil (e.g., epoxidized soybean oil, epoxidized linseed oil, epoxidized sunflower oil), or combinations.

In one embodiment or in combination with any other embodiment, the composition comprises polyethylene glycol having an average molecular weight of from 300 to 500 Daltons. In one embodiment or in combination with any other embodiment, the composition comprises polyethylene glycol having an average molecular weight of from 350 to 550 Daltons

The present application also discloses an article comprising, formed from or prepared using a composition comprising: (1) a cellulose acetate, wherein the cellulose acetate has an acetyl degree of substitution (“DSAc”) in the range of from 2.2 to 2.6, and (2) from 5 to 20 wt % of a polyethylene glycol or a methoxy polyethylene glycol composition having an average molecular weight of from 300 Daltons to 550 Daltons, wherein the composition is melt-processable and may be biodegradable.

In one embodiment or in combination with any other embodiment, the article is formed from an orienting process, an extrusion process, an injection molding process, a blow molding process, or a thermoforming process. In one class of this embodiment, the article is formed from the orienting process. In one subclass of this class, the orienting process is a uniaxial stretching process or a biaxial stretching process.

In one class of this embodiment, the article is formed from the extrusion process. In one class of this embodiment, the article is formed from the injection molding process. In one class of this embodiment, the article is formed from the blow molding process. In one class of this embodiment, the article is formed from a thermoforming process. In one subclass of this class, the film or sheet used to form the article is from 10 to 160 mil thick.

In one embodiment or in combination with any other embodiment, when the article is clear, the article exhibits a haze of less than 10%. In one embodiment or in combination with any other embodiment, when the article is clear, the article exhibits a haze of less than 8%. In one embodiment or in combination with any other embodiment, when the article is clear, the article exhibits a haze of less than 6%. In one embodiment or in combination with any other embodiment, when the article is clear, the article exhibits a haze of less than 5%. In one embodiment or in combination with any other embodiment, when the article is clear, the article exhibits a haze of less than 4%. In one embodiment or in combination with any other embodiment, when the article is clear, the article exhibits a haze of less than 3%. In one embodiment, when the article is clear, the article exhibits a haze of less than 2%. In one embodiment or in combination with any other embodiment, when the article is clear, the article exhibits a haze of less than 1%.

In one embodiment or in combination with any other embodiment, wherein when the composition is formed into a film having a thickness of 0.38 mm, the film exhibits greater than 5% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 10% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 20% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 30% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 50% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 70% disintegration after 6 weeks and greater than 90% disintegration after 12 weeks according to Disintegration Test Protocol, as described in the specification or in the alternative according to ISO 16929 (2013).

In one embodiment or in combination with any other embodiment, when the composition is formed into a film having a thickness of 0.76 mm, the film exhibits greater than 30% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 50% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 70% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 90% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 95% disintegration after 12 weeks according to Disintegration Test Protocol, as described in the specification or in the alternative according to ISO 16929 (2013).

In one embodiment or in combination with any other embodiment, the article exhibits greater than 30% disintegration after 12 weeks according to Disintegration Test Protocol, as described in the specification or in the alternative according to ISO 16929 (2013). In one embodiment or in combination with any other embodiment, the article exhibits greater than 50% disintegration after 12 weeks according to Disintegration Test Protocol, as described in the specification or in the alternative according to ISO 16929 (2013). In one embodiment or in combination with any other embodiment, the article exhibits greater than 70% disintegration after 12 weeks according to Disintegration Test Protocol, as described in the specification or in the alternative according to ISO 16929 (2013). In one embodiment or in combination with any other embodiment, the article exhibits greater than 80% disintegration after 12 weeks according to Disintegration Test Protocol, as described in the specification or in the alternative according to ISO 16929 (2013). In one embodiment or in combination with any other embodiment, the article exhibits greater than 90% disintegration after 12 weeks according to Disintegration Test Protocol, as described in the specification or in the alternative according to ISO 16929 (2013). In one embodiment or in combination with any other embodiment, the article exhibits greater than 95% disintegration after 12 weeks according to Disintegration Test Protocol, as described in the specification or in the alternative according to ISO 16929 (2013).

In one embodiment or in combination with any other embodiment, the article has a thickness of 0.8 mm or less. In one embodiment, the article has a thickness of 0.76 mm or less.

In one embodiment or in combination with any other embodiment, the composition further comprises at least one additional component chosen from a filler, an additive, a biopolymer, a stabilizer, or an odor modifier.

In one embodiment or in combination with any other embodiment, the composition further comprises a filler in an amount of from 1 to 60 wt %, based on the total weight of the composition. In one class of this embodiment, the filler is a carbohydrate, a cellulosic filler, an inorganic filler, a food byproduct, a desiccant, an alkaline filler, or combinations thereof.

In one subclass of this class, the filler is an inorganic filler. In one sub-subclass of this subclass, the inorganic filer is calcium carbonate.

In one subclass of this class, the filler is a carbohydrate. In one subclass of this class, the filler is a cellulosic filler. In one subclass of this class, the filler is a food byproduct. In one subclass of this class, the filler is a desiccant. In one subclass of this class, the filler is an alkaline filler.

In one embodiment or in combination with any other embodiment, the composition further comprises an odor modifying additive in an amount of from 0.001 to 1 wt %, based on the total weight of the composition. In one class of this embodiment, the odor modifying additive is vanillin, Pennyroyal M-1178, almond, cinnamyl, spices, spice extracts, volatile organic compounds or small molecules, or Plastidor. In one subclass of this class, the odor modifying additive is vanillin.

In one embodiment or in combination with any other embodiment, the composition further comprises a stabilizer in an amount from 0.01 to 5 wt %, based on the total composition. In one class of this embodiment, the stabilizer is a UV absorber, an antioxidant (e.g., ascorbic acid, BHT, BHA, etc), an acid scavenger, a radical scavenger, an epoxidized oil (e.g., epoxidized soybean oil, epoxidized linseed oil, epoxidized sunflower oil), or combinations.

The present application also discloses an article comprising a composition comprising: (1) a cellulose acetate, wherein the cellulose acetate has an acetyl degree of substitution (“DSAc”) in the range of from 2.2 to 2.6, (2) from 13-23 wt % of a polyethylene glycol or a methoxy polyethylene glycol composition having an average molecular weight of from 300 Daltons to 550 Daltons, and (3) 0.01-1.8 wt % of an additive chosen from an epoxidized soybean oil, a secondary antioxidant, or a combination, wherein the composition is melt processable, biodegradable, and disintegratable.

In one embodiment or in combination with any other embodiment, the additive is present at from 0.01 to 1 wt %, or 0.05 to 0.8 wt %, or 0.05 to 0.5 wt %, or 0.1 to 1 wt %.

In one embodiment or in combination with any other embodiment, the additive is an epoxidized soybean oil which is present at 0.1 to 1 wt %, or 0.1 to 0.5 wt %, or 0.5 to 1 wt %, or 0.3 to 0.8 wt %.

In one embodiment or in combination with any other embodiment, the additive is a secondary antioxidant which is present at 0.01 to 0.8 wt %, or 0.01 to 0.4 wt %, or 0.4 to 0.8 wt %, or 0.2 to 0.6 wt %.

In one embodiment or in combination with any other embodiment, the composition comprises polyethylene glycol having an average molecular weight of from 300 to 500 Daltons. In one embodiment or in combination with any other embodiment, the composition comprises polyethylene glycol having an average molecular weight of from 350 to 550 Daltons.

In one embodiment or in combination with any other embodiment, the article is formed from an orienting process, an extrusion process, an injection molding process, a blow molding process, or a thermoforming process. In one class of this embodiment, the article is formed from the orienting process. In one subclass of this class, the orienting process is a uniaxial stretching process or a biaxial stretching process.

In one class of this embodiment, the article is formed from the extrusion process. In one class of this embodiment, the article is formed from the injection molding process. In one class of this embodiment, the article is formed from the blow molding process. In one class of this embodiment, the article is formed from a thermoforming process. In one subclass of this class, the film or sheet used to form the article is from 10 to 160 mil thick.

In one embodiment or in combination with any other embodiment, when the article is clear, the article exhibits a haze of less than 10%. In one embodiment or in combination with any other embodiment, when the article is clear, the article exhibits a haze of less than 8%. In one embodiment or in combination with any other embodiment, when the article is clear, the article exhibits a haze of less than 6%. In one embodiment or in combination with any other embodiment, when the article is clear, the article exhibits a haze of less than 5%. In one embodiment or in combination with any other embodiment, when the article is clear, the article exhibits a haze of less than 4%. In one embodiment or in combination with any other embodiment, when the article is clear, the article exhibits a haze of less than 3%. In one embodiment, when the article is clear, the article exhibits a haze of less than 2%. In one embodiment or in combination with any other embodiment, when the article is clear, the article exhibits a haze of less than 1%.

In one embodiment or in combination with any other embodiment, wherein when the composition is formed into a film having a thickness of 0.38 mm, the film exhibits greater than 5% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 10% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 20% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 30% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 50% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a film having a thickness of 0.38 mm, the film exhibits greater than 70% disintegration after 6 weeks and greater than 90% disintegration after 12 weeks according to Disintegration Test Protocol, as described in the specification or in the alternative according to ISO 16929 (2013).

In one embodiment or in combination with any other embodiment, when the composition is formed into a film having a thickness of 0.76 mm, the film exhibits greater than 30% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 50% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 70% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 90% disintegration after 12 weeks according to Disintegration Test Protocol, as described in the specification or in the alternative according to ISO 16929 (2013). In one embodiment or in combination with any other embodiment, when the composition is formed into a film having a thickness of 0.76 mm, the film exhibits greater than 95% disintegration after 12 weeks according to Disintegration Test Protocol, as described in the specification or in the alternative according to ISO 16929 (2013).

In one embodiment or in combination with any other embodiment, the article exhibits greater than 30% disintegration after 12 weeks according to Disintegration Test Protocol, as described in the specification or in the alternative according to ISO 16929 (2013). In one embodiment or in combination with any other embodiment, the article exhibits greater than 50% disintegration after 12 weeks according to Disintegration Test Protocol, as described in the specification or in the alternative according to ISO 16929 (2013). In one embodiment or in combination with any other embodiment, the article exhibits greater than 70% disintegration after 12 weeks according to Disintegration Test Protocol, as described in the specification or in the alternative according to ISO 16929 (2013). In one embodiment or in combination with any other embodiment, the article exhibits greater than 80% disintegration after 12 weeks according to Disintegration Test Protocol, as described in the specification or in the alternative according to ISO 16929 (2013). In one embodiment or in combination with any other embodiment, the article exhibits greater than 90% disintegration after 12 weeks according to Disintegration Test Protocol, as described in the specification or in the alternative according to ISO 16929 (2013). In one embodiment or in combination with any other embodiment, the article exhibits greater than 95% disintegration after 12 weeks according to Disintegration Test Protocol, as described in the specification or in the alternative according to ISO 16929 (2013).

In one embodiment or in combination with any other embodiment, the article has a thickness of 0.8 mm or less. In one embodiment, the article has a thickness of 0.76 mm or less.

In one embodiment or in combination with any other embodiment, the composition further comprises at least one additional component chosen from a filler, an additive, a biopolymer, a stabilizer, or an odor modifier.

In one embodiment or in combination with any other embodiment, the composition further comprises a filler in an amount of from 1 to 60 wt %, based on the total weight of the composition. In one class of this embodiment, the filler is a carbohydrate, a cellulosic filler, an inorganic filler, a food byproduct, a desiccant, an alkaline filler, or combinations thereof.

In one subclass of this class, the filler is an inorganic filler. In one sub-subclass of this subclass, the inorganic filler is calcium carbonate.

In one subclass of this class, the filler is a carbohydrate. In one subclass of this class, the filler is a cellulosic filler. In one subclass of this class, the filler is a food byproduct. In one subclass of this class, the filler is a desiccant. In one subclass of this class, the filler is an alkaline filler.

In one embodiment or in combination with any other embodiment, the composition further comprises an odor modifying additive in an amount of from 0.001 to 1 wt %, based on the total weight of the composition. In one class of this embodiment, the odor modifying additive is vanillin, Pennyroyal M-1178, almond, cinnamyl, spices, spice extracts, volatile organic compounds or small molecules, or Plastidor. In one subclass of this class, the odor modifying additive is vanillin.

In one embodiment or in combination with any other embodiment, the foamable composition exhibits a heat deflection temperature of greater than 100° C. as measured at 0.45 MPa at 2% elongation with a 1 Hz frequency using a DMA. In one embodiment or in combination with any other embodiment, the foamable composition exhibits a heat deflection temperature of greater than 102° C. as measured at 0.45 MPa at 2% elongation with a 1 Hz frequency using a DMA. In one embodiment or in combination with any other embodiment, the foamable composition exhibits a heat deflection temperature of greater than 104° C. as measured at 0.45 MPa at 2% elongation with a 1 Hz frequency using a DMA. In one embodiment or in combination with any other embodiment, the foamable composition exhibits a heat deflection temperature of greater than 106° C. as measured at 0.45 MPa at 2% elongation with a 1 Hz frequency using a DMA. In one embodiment or in combination with any other embodiment, the foamable composition exhibits a heat deflection temperature of greater than 110° C. as measured at 0.45 MPa at 2% elongation with a 1 Hz frequency using a DMA. In one embodiment or in combination with any other embodiment, the foamable composition exhibits a heat deflection temperature of greater than 115° C. as measured at 0.45 MPa at 2% elongation with a 1 Hz frequency using a DMA.

In one embodiment or in combination with any other embodiment, the blowing agent comprises sodium bicarbonate, citric acid or combination thereof. In one class of this embodiment, the blowing agent comprises sodium bicarbonate. In one class of this embodiment, the blowing agent comprises citric acid.

In one embodiment or in combination with any other embodiment, the carrier polymer comprises polybutylene succinate, polycaprolactone, or combinations thereof. In one class of this embodiment, the carrier polymer comprises polybutylene succinate. In one class of this embodiment, the carrier polymer comprises polycaprolactone.

In one embodiment or in combination with any other embodiment, the plasticizer comprises triacetin, triethyl citrate, or PEG400.

In one class of this embodiment, the plasticizer is present in a range of from 3 to 30 wt %. In one class of this embodiment, the plasticizer is present in a range of from 3 to 30 or from 3 to 25 wt %.

In one class of this embodiment, the plasticizer comprises triacetin.

In one subclass of this class, the plasticizer is present in a range of from 3 to 30 wt %. In one subclass of this class, the plasticizer is present in a range of from 3 to 30 or 3 to 25 wt %.

In one class of this embodiment, the plasticizer comprises triethyl citrate. In one subclass of this class, the plasticizer is present in a range of from 3 to 30 wt %. In one subclass of this class, the plasticizer is present in a range of from 3 to 30 or 3 to 25 wt %.

In one class of this embodiment, the plasticizer comprises PEG400. In one subclass of this class, the plasticizer is present in a range of from 3 to 30 wt %. In one subclass of this class, the plasticizer is present in a range of from 3 to 30 or 3 to 25 wt %.

In one embodiment or in combination with any other embodiment, the nucleating agent comprises a magnesium silicate, a silicon dioxide, a magnesium oxide, or combinations thereof. In one class of this embodiment, the nucleating agent comprises a particulate composition with a median particle size less than 2 microns. In one class of this embodiment, the nucleating agent comprises a particulate composition with a median particle size less than 1.5 microns. In one class of this embodiment, the nucleating agent comprises a particulate composition with a median particle size less than 1.1 microns.

In one class of this embodiment, the nucleating agent comprises a magnesium silicate. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one class of this embodiment, the nucleating agent comprises a silicon dioxide. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one class of this embodiment, the nucleating agent comprises a magnesium oxide. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one embodiment or in combination with any other embodiment, the nucleating agent comprises a particulate composition with a median particle size less than 2 microns. In one embodiment, the nucleating agent comprises a particulate composition with a median particle size less than 1.5 microns. the nucleating agent comprises a particulate composition with a median particle size less than 1.1 microns.

In one embodiment or in combination with any other embodiment, the foamable composition further comprises a fiber. In one class of this embodiment, the fiber comprises hemp, bast, jute, flax, ramie, kenaf, sisal, bamboo, or wood cellulose fibers. In one subclass of this class, the fiber comprises hemp.

In one embodiment or in combination with any other embodiment, the foamable composition further comprises a photodegradation cellulose catalyst. In one class of this embodiment, the photodegradation cellulose catalyst is a titanium dioxide, or an iron oxide. In one subclass of this class, the photodegradation cellulose catalyst is a titanium dioxide. In one subclass of this class, the photodegradation cellulose catalyst is an iron oxide.

In one embodiment or in combination with any other embodiment, the foamable composition further comprises a pigment. In one class of this embodiment, the pigment is a titanium dioxide, a cellulose carbon black, or an iron oxide. In one subclass of this class, the pigment is a titanium dioxide. In one subclass of this class, the pigment is a cellulose carbon black. In one subclass of this class, the pigment is an iron oxide.

In one embodiment or in combination with any other embodiment, the foamable composition is biodegradable.

In one embodiment or in combination with any other embodiment, the foamable composition comprises two or more cellulose acetates having different degrees of substitution of acetyl.

In one embodiment or in combination with any other embodiment, the foamable composition further comprises a biodegradable polymer that is different than the cellulose acetate.

In one embodiment or in combination with any other embodiment, there is an article prepared from any one of the previously described foamable compositions, wherein the article is a foam or a foam article.

In one class of this embodiment, the article has a thickness of up to 3 mm.

In one class of this embodiment, the article has one or more skin layers. The skin layer may be found on the outer surface of the article or foam. The skin layer cellulose acetate also be found in the middle of the foam.

In one class of this embodiment, the article is biodegradable.

In one or more embodiments, in particular for embodiments wherein the article is a foam or a foam article, density of the foam is an important parameter insofar as it may influence various article performance properties such as water barrier, stiffness and thermal conductivity. In one class of this embodiment, the article has a density or the article includes foam with a density less than 0.9 g/cm³. In one class of this embodiment, the article has a density or the article includes foam with a density of less than 0.8 g/cm³. In one class of this embodiment, the article has a density or the article includes foam with a density of less than 0.7 g/cm³. In one class of this embodiment, the article has a density or the article includes foam with a density of less than 0.6 g/cm³. In one class of this embodiment, the article has a density or the article includes foam with a density 0f less than 0.5 g/cm³. In one class of this embodiment, the article has a density or the article includes foam with a density of less than 0.4 g/cm³. In one class of this embodiment, the article has a density or the article includes foam with a density of less than 0.3 g/cm³. In one class of this embodiment, the article has a density or the article includes foam with a density of less than 0.2 g/cm³. In one class of this embodiment, the article has a density or the article includes foam with a density of less than 0.1 g/cm³. In one class of this embodiment, the article has a density or the article includes foam with a density of less than 0.05 g/cm³. In one class of this embodiment, the article has a density or the article includes foam with a density in the range of from 0.2 to 0.9 g/cm³. In one or more embodiments, the article has a density, or the article includes foam with a density, of from 0.01 to 0.2 g/cm³.

In one class of this embodiment, the article is industrial compostable or home compostable. In one subclass of this class, the article is industrial compostable. In one sub-subclass of this subclass, the article has a thickness that is less than 1.1 mm. In one sub-subclass of this subclass, the article has a thickness that is less than 0.8 mm. In one sub-subclass of this subclass, the article has a thickness that is less than 0.4 mm.

In one subclass of this class, the article is home compostable. In one sub-subclass of this subclass, the article has a thickness that is less than 1.1 mm. In one sub-subclass of this subclass, the article has a thickness that is less than 0.8 mm. In one sub-subclass of this subclass, the article has a thickness that is less than 0.6 mm. In one sub-subclass of this subclass, the article has a thickness that is less than 0.4 mm.

In one embodiment or in combination with any other embodiment, wherein when the composition is formed into a foam having a thickness of 0.38 mm, the foam exhibits greater than 5% disintegration after 6 weeks and greater than 90% disintegration after 12 weeks according to the Disintegration Test Protocol, as described in the specification or in the alternative according to ISO 16929 (2013). In one embodiment or in combination with any other embodiment, wherein when the composition is formed into a foam having a thickness of 0.38 mm, the foam exhibits greater than 10% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a foam having a thickness of 0.38 mm, the foam exhibits greater than 20% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a foam having a thickness of 0.38 mm, the foam exhibits greater than 30% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a foam having a thickness of 0.38 mm, the foam exhibits greater than 50% disintegration after 6 weeks and greater than 90% disintegration after 12 weeks according to Disintegration Test Protocol, as described in the specification or in the alternative according to ISO 16929 (2013). In one embodiment or in combination with any other embodiment, wherein when the composition is formed into a foam having a thickness of 0.38 mm, the foam exhibits greater than 70% disintegration after 6 weeks and greater than 90% disintegration after 12 weeks according to Disintegration Test Protocol, as described in the specification or in the alternative according to ISO 16929 (2013).

In one embodiment or in combination with any other embodiment, when the composition is formed into a foam having a thickness of 0.76 mm, the foam exhibits greater than 30% disintegration after 12 weeks according to Disintegration Test Protocol, as described in the specification or in the alternative according to ISO 16929 (2013). In one embodiment or in combination with any other embodiment, when the composition is formed into a foam having a thickness of 0.76 mm, the foam exhibits greater than 50% disintegration after 12 weeks according to Disintegration Test Protocol, as described in the specification or in the alternative according to ISO 16929 (2013). In one embodiment or in combination with any other embodiment, when the composition is formed into a foam having a thickness of 0.76 mm, the foam exhibits greater than 70% disintegration after 12 weeks according to Disintegration Test Protocol, as described in the specification or in the alternative according to ISO 16929 (2013). In one embodiment or in combination with any other embodiment, when the composition is formed into a foam having a thickness of 0.76 mm, the foam exhibits greater than 90% disintegration after 12 weeks according to Disintegration Test Protocol, as described in the specification or in the alternative according to ISO 16929 (2013). In one embodiment or in combination with any other embodiment, when the composition is formed into a foam having a thickness of 0.76 mm, the foam exhibits greater than 95% disintegration after 12 weeks according to Disintegration Test protocol, as described in the specification or in the alternative according to ISO 16929 (2013).

In one or more embodiments, the present invention may be a foamable composition that includes: (i) a cellulose acetate; (ii) fatty acid; (iii) optionally a processing aid; (iv) optionally a nucleating agent; (v) blowing agent. In one or more embodiments, the foamable composition may include (1) a cellulose acetate having a degree of substitution of acetyl (DS_{Ac}) between 2.2 to 2.6; (2) 5 to 40 wt % of a plasticizer; (3) 0.1 to 3 wt % of a nucleating agent; and (4) 0.1 to 15 wt % of a physical blowing agent, wherein the proportions of the cellulose acetate, plasticizer, nucleating agent and physical blowing agent are based on the total weight of the foamable composition. The blowing agent is preferably a physical blowing agent.

In one embodiment or in combination with any other embodiment, the foamable composition exhibits a heat deflection temperature (HDT) of greater than 100° C. as measured at 0.45 MPa at 2% elongation with a 1 Hz frequency using a DMA. In one embodiment or in combination with any other embodiment, the foamable composition exhibits a heat deflection temperature of greater than 102° C. as measured at 0.45 MPa at 2% elongation with a 1 Hz frequency using a DMA. In one embodiment or in combination with any other embodiment, the foamable composition exhibits a heat deflection temperature of greater than 104° C. as measured at 0.45 MPa at 2% elongation with a 1 Hz frequency using a DMA. In one embodiment or in combination with any other embodiment, the foamable composition exhibits a heat deflection temperature of greater than 106° C. as measured at 0.45 MPa at 2% elongation with a 1 Hz frequency using a DMA. In one embodiment or in combination with any other embodiment, the foamable composition exhibits a heat deflection temperature of greater than 110° C. as measured at 0.45 MPa at 2% elongation with a 1 Hz frequency using a DMA. In one embodiment or in combination with any other embodiment, the foamable composition exhibits a heat deflection temperature of greater than 115° C. as measured at 0.45 MPa at 2% elongation with a 1 Hz frequency using a DMA.

The heat deflection temperature is a measure of a material's resistance to distortion under a constant load at elevated temperature. For example, ASTM D648 and ISO 75 both measure HDT (heat deflection temperature) on test samples after equilibration of the test materials. Briefly, a test bar is molded of a specific thickness and width. The test sample is submerged in oil for which the temperature is raised at a uniform rate (usually 2° C. per minute). The load is applied to the midpoint of the test bar that is supported near both ends. The temperature at which a bar of material is deformed 0.25 mm is recorded as the HDT.

In one embodiment or in combination with any other embodiment, the physical blowing agent comprises CO₂, N₂, unbranched or branched (C₂₋₆) alkane, or any combination thereof. In one class of this embodiment, the physical blowing agent comprises CO₂. In one class of this embodiment, the physical blowing agent comprises N₂. In one class of this embodiment, the physical blowing agent comprises unbranched or branched (C₂₋₆) alkane.

In one embodiment or in combination with any other embodiment, the physical blowing agent is present from 0.1 to 0.5 wt %. In one embodiment or in combination with any other embodiment, the physical blowing agent is present from 0.5 to 4 wt %. In one embodiment or in combination with any other embodiment, the physical blowing agent is present from 0.3 to 4 wt %. In one embodiment or in combination with any other embodiment, the physical blowing agent is present from 4 to 10 wt %.

In one embodiment or in combination with any other embodiment, the plasticizer comprises triacetin, triethyl citrate, or PEG400.

In one class of this embodiment, the plasticizer is present in a range of from 3 to 30% wt %. In one class of this embodiment, the plasticizer is present in a range of from 3 to 25 wt % or 3 to 20 wt. % or 3 to 15 wt. %.

In one class of this embodiment, the plasticizer comprises triacetin.

In one subclass of this class, the plasticizer is present in a range of from 3 to 30 wt %. In one subclass of this class, the plasticizer is present in a range of from 3 to 25 wt % or 3 to 20 wt. % or 3 to 15 wt. %.

In one class of this embodiment, the plasticizer comprises triethyl citrate. In one subclass of this class, the plasticizer is present in a range of from 3 to 30 wt %. In one subclass of this class, the plasticizer is present in a range of from 3 to 25 wt % or 3 to 20 wt. % or 3 to 15 wt. %.

In one class of this embodiment, the plasticizer comprises PEG400. In one subclass of this class, the plasticizer is present in a range of from 3 to 30 wt %. In one subclass of this class, the plasticizer is present in a range of from 3 to 25 wt % or 3 to 20 wt. % or 3 to 15 wt. %.

In one embodiment or in combination with any other embodiment wherein the foamable composition includes a nucleating agent, the nucleating agent comprises a magnesium silicate, a silicon dioxide, a magnesium oxide, or combinations thereof. In one class of this embodiment, the nucleating agent comprises a particulate composition with a median particle size less than 2 microns. In one class of this embodiment, the nucleating agent comprises a particulate composition with a median particle size less than 1.5 microns. In one class of this embodiment, the nucleating agent comprises a particulate composition with a median particle size less than 1.1 microns.

In one class of this embodiment, the nucleating agent comprises a magnesium silicate. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one class of this embodiment, the nucleating agent comprises a silicon dioxide. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one class of this embodiment, the nucleating agent comprises a magnesium oxide. In one subclass of this class, the nucleating agent comprises a particulate composition with a median particle size less than 2 microns. In one subclass of this class, the nucleating agent comprises a particulate composition with a median particle size less than 1.5 microns. In one subclass of this class, the nucleating agent comprises a particulate composition with a median particle size less than 1.1 microns.

In one embodiment or in combination with any other embodiment, the nucleating agent comprises a particulate composition with a median particle size less than 2 microns. In one embodiment, the nucleating agent comprises a particulate composition with a median particle size less than 1.5 microns. the nucleating agent comprises a particulate composition with a median particle size less than 1.1 microns.

In one embodiment or in combination with any other embodiment, the foamable composition further comprises a fiber. In one class of this embodiment, the fiber comprises hemp, bast, jute, flax, ramie, kenaf, sisal, bamboo, or wood cellulose fibers. In one subclass of this class, the fiber comprises hemp.

In one embodiment or in combination with any other embodiment, the foamable composition further comprises a photodegradation catalyst. In one class of this embodiment, the photodegradation catalyst is a titanium dioxide, or an iron oxide. In one subclass of this class, the photodegradation catalyst is a titanium dioxide. In one subclass of this class, the photodegradation catalyst is an iron oxide.

In one embodiment or in combination with any other embodiment, the foamable composition further comprises a pigment. In one class of this embodiment, the pigment is a titanium dioxide, a carbon black, or an iron oxide. In one subclass of this class, the pigment is a titanium dioxide. In one subclass of this class, the pigment is a carbon black. In one subclass of this class, the pigment is an iron oxide.

In one embodiment or in combination with any other embodiment, the foamable composition is biodegradable.

In one embodiment or in combination with any other embodiment, the foamable composition comprises two or more cellulose acetates having different degrees of substitution of acetyl.

In one embodiment or in combination with any other embodiment, the foamable composition further comprises a biodegradable polymer that is different than the cellulose acetate.

In one embodiment or in combination with any other embodiment, there is an article prepared from any one of the previously described foamable compositions, wherein the article is a foam or a foam article. In one or more embodiments, the foam article is formed from or includes a foam of the present invention.

In one class of this embodiment, the article has a thickness or foam thickness of up to 3 mm.

In one class of this embodiment, the article has one or more skin layers.

In one class of this embodiment, the article is a melt-formed article that may be one or more of biodegradable, disintegratable and compostable.

In one class of this embodiment, the article includes foam with a density less than 0.9 g/cm³. In one class of this embodiment, the article has a density, or the article includes foam with a density, of less than 0.8 g/cm³. In one class of this embodiment, the article has a density, or the article includes foam with a density of less than 0.7 g/cm³. In one class of this embodiment, the article has a density of less than 0.6 g/cm³. In one class of this embodiment, the article has a density, or the article includes foam with a density, of less than 0.5 g/cm³. In one class of this embodiment, the article has a density, or the article includes foam with a density, of less than 0.4 g/cm³. In one class of this embodiment, the article has a density, or the article includes foam with a density of less than 0.3 g/cm³. In one class of this embodiment, the article has a density, or the article includes foam with a density of less than 0.2 g/cm³. In one class of this embodiment, the article has a density, or the article includes foam with a density, of less than 0.1 g/cm³. In one class of this embodiment, the article has a density, or the article includes foam with a density of less than 0.05 g/cm³. In one class of this embodiment, the article has a density in the range of from 0.2 to 0.9 g/cm³.

In one class of this embodiment, the article is industrial compostable or home compostable. In one subclass of this class, the article is industrial compostable. In one sub-subclass of this subclass, the article has a thickness that is less than 6 mm. In one sub-subclass of this subclass, the article has a thickness that is less than 3 mm. In one sub-subclass of this subclass, the article has a thickness that is less than 1.1 mm. In one subclass of this class, the article is home compostable. In one sub-subclass of this subclass, the article has a thickness that is less than 6 mm. In one sub-subclass of this subclass, the article has a thickness that is less than 3 mm. In one sub-subclass of this subclass, the article has a thickness that is less than 1.1 mm. In one sub-subclass of this subclass, the article has a thickness that is less than 0.8 mm. In one sub-subclass of this subclass, the article has a thickness that is less than 0.6 mm. In one sub-subclass of this subclass, the article has a thickness that is less than 0.4 mm.

In one embodiment or in combination with any other embodiment, the article has a thickness that is less than 6 mm. In one embodiment or in combination with any other embodiment, the article has a thickness that is less than 3 mm. In one embodiment or in combination with any other embodiment, the article has a thickness that is less than 1.1 mm. In one embodiment or in combination with any other embodiment, the article has a thickness that is less than 0.8 mm. In one embodiment or in combination with any other embodiment, the article has a thickness that is less than 0.6 mm. In one embodiment or in combination with any other embodiment, the article has a thickness that is less than 0.4 mm.

The present application discloses a method for preparing a foamable composition comprising: (a) providing a nonfoamable composition comprising (1) a cellulose acetate having a degree of substitution of acetyl (DS_{Ac}) between 2.2 to 2.6, (2) 5 to 40 wt % of a plasticizer, and (3) 0.1 to 3 wt % of a nucleating agent; (b) melting the nonfoamable composition in an extruder to form a melt of the nonfoamble composition; and (b) injecting a physical blowing agent into the melt of the nonfoamable composition to prepare a melted foamable composition.

In one embodiment or in combination with any other embodiment, the physical blowing agent comprises CO₂, N₂ or an unbranched or branched (C₂₋₆) alkane.

In one embodiment or in combination with any other embodiment, the article exhibits greater than 30% disintegration after 12 weeks according to Disintegration Test Protocol, as described in the specification or in the alternative according to ISO 16929 (2013). In one embodiment or in combination with any other embodiment, the article exhibits greater than 50% disintegration after 12 weeks according to Disintegration Test Protocol, as described in the specification or in the alternative according to ISO 16929 (2013). In one embodiment or in combination with any other embodiment, the article exhibits greater than 70% disintegration after 12 weeks according to Disintegration Test Protocol, as described in the specification or in the alternative according to ISO 16929 (2013). In one embodiment or in combination with any other embodiment, the article exhibits greater than 80% disintegration after 12 weeks according to Disintegration Test Protocol, as described in the specification or in the alternative according to ISO 16929 (2013). In one embodiment or in combination with any other embodiment, the article exhibits greater than 90% disintegration after 12 weeks according to Disintegration Test Protocol, as described in the specification or in the alternative according to ISO 16929 (2013). In one embodiment or in combination with any other embodiment, the article exhibits greater than 95% disintegration after 12 weeks according to Disintegration Test Protocol, as described in the specification or in the alternative according to ISO 16929 (2013).

### EXAMPLES

### Abbreviations

CA is cellulose acetate; CA-398-30 is Eastman Cellulose Acetate CA-398-30; d is day; DSC is differential scanning calorimetry; Ex is example(s); FA is fatty acid; GC is gas chromatography; h is hour; HIPS is high impact polystyrene; LA is lauric acid; MA is myristic acid; MD is machine direction; min is minute(s); mp is melting point; PA is palmitic acid; RH is relative humidity; SA is stearic acid; ST is sheet temperature; TA is triacetin; TD is transverse direction; Tg is glass transition temperature; Vikoflex is Vikoflex 7170; wt % is weight percent.

### Example 1. FA Miscibility; Tg Suppression

CA-398-30 with a DS of 2.4 to 2.5 was dissolved in acetone. FA or FA blends were added at 1% to 5% of the total weight of solids, as indicated in Table 1 to form a dope with 15 wt % total solids. Films were cast with a dry thickness of about 10 mil (0.254 mm). The films were analyzed by DSC, and miscibility was determined by the presence of a single temperature transition in the DSC thermogram during the second heat. The appearance of the film by visual assessment is noted.

TABLE 1
Appearance and Tg of solvent-cast films with CA-398-30 and FA

| | | | | Tg | |
|---|---|---|---|---|---|
| | | | | (DSC, | |
| | FA and | | | 2^{nd} | |
| Sample | loading | | Film | heat) | Other transitions in DSC |
| # | (wt %) | | appears | (° C.) | thermograms |
| 1 | LA | 1 | clear | 176.71 | |
| 2 | | 3 | clear | 168.11 | |
| 3 | | 5 | clear | 159.37 | |
| 4 | MA | 1 | clear | 178.44 | |
| 5 | | 3 | crystals | 179.13 | 1^{st} heat, mp at 55.22° C. |
| | | | | | (0.9088 cal/g) |
| 6 | | 5 | crystals | 176.73 | 1^{st} heat, mp at 54.59° C. |
| | | | | | (1.071 cal/g) |
| 7 | PA | 1 | hazy | 177.54 | ° C. |
| 8 | | 3 | crystals | 176.97 | 1^{st} heat, mp at 63.09° C. |
| | | | | | (0.6425 cal/g) |
| 9 | | 5 | crystals | 173.42 | 1^{st} heat, mp at 63.16° C. |
| | | | | | (1.161 cal/g) |
| | | | | | 2^{nd} heat, mp at 62.51° C. |
| | | | | | (0.6207 cal/g) |
| 10 | SA | 1 | crystals | 181.87 | 1^{st} heat, mp at 69.38° C. |
| | | | | | (0.4307 cal/g) |
| | | | | | 2^{nd} heat, mp at 69.08° C. |
| | | | | | (0.1121 cal/g) |
| 11 | | 3 | crystals | 191.54 | 1^{st} heat, mp at 70.20° C. |
| | | | | | (1.423 cal/g) |
| | | | | | 2^{nd} heat, mp at 69.41° C. |
| | | | | | (0.7242 cal/g) |
| 12 | | 5 | crystals | 192.18 | ° C. |
| | | | | | 2^{nd} heat, mp at 69.28° C. |
| | | | | | (1.756 cal/g) |

### Example 2. Eutectic FA Blends

Solutions of eutectic blends of FA blends A to G in Table 2 below were made as 10% solids in acetone and films formed and tested in accordance with Ex 1 with results set forth in Tables 2 and 3 below.

TABLE 2
Binary and ternary FA blends used as 10% solutions in acetone.

| FA blend | FA (Ratio) | Mp onset (° C.) |
|---|---|---|
| A | LA:MA (66:34) | 34 |
| B | LA:PA (77:23) | 33 |
| C | LA:SA (66:34) | 31 |
| D | MA:SA (64:36) | 44 |
| E | LA:MA:PA (60:20:20) | 29 |
| F | PA:SA (64:36) | 52 |
| G | MA:PA (60:40) | 43 |

TABLE 3
Appearance and Tg of solvent-cast films with
CA-398-30 (97 wt %) and FA blends (3 wt %)

| | FA | | Tg, DSC | |
|---|---|---|---|---|
| Sample | Blend | | 2^{nd} heat | |
| # | (3 wt %) | Appears | (° C.) | Other |
| 13 | A | Clear | 166.12 | |
| 14 | B | Clear | 167.33 | |
| 15 | C | Hazy | 168.11 | mp in 1^{st} heat |
| | | | | (~62° C.) |
| 16 | D | Hazy | 170.90 | |
| 17 | E | Clear | 168.21 | |
| 18 | F | Hazy | 167.63 | mp in 1^{st} heat |
| | | | | (~52° C.) |
| 26 | G | clear | 169.9 | |

### Example 3. Fatty Acid Blends with Plasticized CA (TA (15 wt %)); Melt-Pressed Films

Dry blends of CA-398-30 with TA (15 wt %) and 3% FA (3 wt %) were combined for melt pressing films of 10 mil (0.254 mm). The blends were dried for 24 h at 80° C.

Films were pressed for a total of 3.5 min on a heated press with the upper and lower platens pre-heated to 425° F. (218° C.). The pre-dried CA/TA/FA blend was applied to the center of a 4-inch square, 10 mil (0.254 mm) thick frame with a top and bottom layer of aluminum foil, between steel plates. The assembly was placed in the press and heated for 1 min at 0 pressure to dry and pre-melt the puck, then pressed for 1 min at 12,000 PHI, (ram force in pounds) bumped up to higher pressure over ˜30 seconds, and held 1 min at 20,000 PHI.

The appearance and T_{g} of the films are shown below.

TABLE 4
Binary and ternary FA blends, dry-
blended as solids with CA and TA.

| CA-398- | Vikoflex | TA | FA Blend | MP Onset | Pressed Film |
|---|---|---|---|---|---|
| 30 (wt %) | (wt %) | (wt %) | (wt %) | (° C.) | Appearance |
| 81 | 1 | 15 | A (3) | 34 | Clear |
| 81 | 1 | 15 | B (3) | 33 | Clear |
| 81 | 1 | 15 | C (3) | 31 | White streaks, |
| | | | | | surface bloom |
| 81 | 1 | 15 | D (3) | 44 | White streaks, |
| | | | | | surface bloom |
| 81 | 1 | 15 | E (3) | 29 | Clear |
| 81 | 1 | 15 | F (3) | 52 | White streaks, |
| | | | | | surface bloom |
| 81 | 1 | 15 | G (3) | 43 | Clear |

TABLE 5
Tg of compression molded films with CA-398-30, Vikoflex
(1 wt %), TA (15 wt %) and FA blends (3 wt %).

| | Tg, DSC | |
|---|---|---|
| | 2^{nd} heat | |
| Composition | (° C.) | Other |
| CA-398-30:Vikoflex:TA:FA blend | 116.91 | |
| A (81:1:15:3) | | |
| CA-398-30:Vikoflex:TA:FA blend | 124.51 | |
| B (81:1:15:3) | | |
| CA-398-30:Vikoflex:TA:FA blend | 123.15 | |
| C (81:1:15:3) | | |
| CA-398-30:Vikoflex:TA:FA blend | 122.85 | |
| D (81:1:15:3) | | |
| CA-398-30:Vikoflex:TA:FA blend | 117.35 | |
| E (81:1:15:3) | | |
| CA-398-30:Vikoflex:TA:FA blend | 124.12 | 1^{st} heat, mp at 54.51° C. |
| F (81:1:15:3) | | 2^{nd} heat, mp at 53.90° C. |
| CA-398-30:Vikoflex:TA:FA blend | 116.77 | |
| G (81:1:15:3) | | |

### Example 4. Compounding & Extrusion of CA-398-30 with Vikoflex (1 wt %), Triacetin (18-20 wt %) and FA Blend I (Lauric Acid:Myristic Acid [3:1]) [2 Wt %]

TABLE 6
Formulations

| Sample | Additives |
|---|---|
| A | TA (20 wt %) |
| B | TA (18 wt %), FA blend I |
| | (2 wt %) |

20 lbs of pellets were compounded for each formulation, then 30 mil (0.762 mm) extruded films for characterization. Compounding conditions: An 18 mm Leistritz twin screw extruder with a single-hole die and a screw design was used to extrude pellets which were then later used for the film extrusion. These pellets were made from raw materials consisting of a powder (CA 398-30), a liquid plasticizer (TA) and an acid scavenger to assist in prevention of color generation and molecular weight break-down (Vikoflex 7170; epoxidized soybean oil). The Vikoflex was added to base powder and dry-blended to produce a free-flowing powder and added to a Coperion twin-screw weight-loss feeder. The plasticizer was fed into zone 2 by a liquid injection unit accompanied by a Witte gear pump, Hardy 4060 controller, and injector with a 0.020″ bore. Compounded strands were run through a water trough and pelletized using a ConAir pelletizer.

Representative extruder conditions are detailed below in Table 7

TABLE 7
Extruder Conditions

| Load/Torque (%) | 17 |
|---|---|
| Screw RPM (rpm) | 568 |
| Melt Temperature (° C.) | 260 |
| Melt Pressure (psi) | 575 |
| Die Type/Inj. Size | 1/SMALL |
| Sample Size (lbs) | 20 |
| SEI (kW per Kg/h) | 0.135 |

| Barrel Temperature (° C.) | Set | Actual |
|---|---|---|
| Zone 1 | 80 | 80 |
| Zone 2 | 160 | 160 |
| Zone 3 | 200 | 200 |
| Zone 4 | 215 | 215 |
| Zone 5 | 215 | 215 |
| Zone 6 | 215 | 215 |
| Zone 7 | 225 | 225 |
| Zone 8 | 225 | 225 |
| Zone 9 | 240 | 240 |
| Die 1 | 240 | 240 |
| Die 2 | 240 | 240 |
| | Rate | Percent |
| Feeder 1 | 16.4 | 42 |
| Feeder 2 | | |
| Feeder 3 | | |
| Liquid Feeder | 3.6 | 19.8 |

| | Material in Sample |
|---|---|
| Material No. 1 | 79.00 wt % |
| | CA-398-30 |
| Material No. 2 | 18.00 wt % |
| | Triacetin |
| Material No. 3 | 1.00 wt % |
| | Vikoflex 7170 |
| Material No. 4 | 2.00 wt % |
| | Blend (fatty acids) |

The 30 mil extruded films from both Samples A and B in this Example, referred to as films A and B in Ex 5 below, appeared clear and transparent upon visual inspection.

### Example 5. Tg and Specific Heat Capacity (DSC)

The 30 mil (0.762 mm) films A and B from Ex 4 were analyzed by DSC to measure Heat capacity and Tg. The FA blend I added at 2% led to an increase in the specific heat capacity of the 30 mil (0.762 mm) film but did not change the film Tg. Results are shown in Table 8 below.

TABLE 8

| | | Specific heat | |
|---|---|---|---|
| | | capacity (DSC, | Tg (DSC 2^{nd} |
| FILM | Composition | 1^{st} heat, 23° C.) | heat) (° C.) |
| 5-A | TA (20 wt %), Vikoflex | 1.77-1.86 | 118 |
| | (1 wt %) | | |
| 5-B | TA (18 wt %),, Vikoflex | 2.40 | 118 |
| | (1 wt %), FA Blend I (2 wt %) | | |

### Example 6. 2% Moisture Uptake

The 30 mil films from Ex 4 were incubated for 7 days at 50° C. and 100% RH, simulating extreme conditions that might be encountered, for example, during storage in a warehouse. The 30 mil (0.762 mm) extruded films were cut into 4 inch (101.6 mm) squares and pre-dried at 80° C. for 2 h before recording the dry weight. Test samples were placed upright in a peg rack to minimize any contact with the film surface, and the rack was placed inside a plastic box with a tight-fitting lid. An open container of DI water with a large surface area was also placed in the box, the lid was snapped on and the closed box was incubated in an oven at 50° C. The inside of the box was maintained at close to 100% RH. After 7 days, the “wet” weight of the samples was recorded immediately after opening the box. (average % weight gain, n=4). The results are shown in Table 9 below. The FA blend I at 2% reduced the equilibrium moisture uptake.

TABLE 9
Equilibrium moisture uptake after 7 d at 50° C., 100% RH

| Sample | Average % weight gain, n = 4 |
|---|---|
| 5-A | 3.4 |
| 5-B | 2.2 |

### Example 7. Impact of 2% FA Blend on Elongation at Break

Tensile properties were collected on the 30 mil extruded films from Ex 4 according to ASTM D882. The results are shown in Table 10 below. Addition of FA blend I (2 wt %) surprisingly substantially increased the Break strain (elongation at break; bottom row in bold font).

TABLE 10

| | ASTM D882/FILM | | | |
|---|---|---|---|---|
| | | | Film B | |
| | Film A | | CA-398-30 (80 wt %), | |
| | CA-398-30 (80 wt %), | | TA (18 wt %), Vikoflex | |
| | TA (20 wt %), | | (1 wt %), FA Blend I | |
| | Vikoflex (1 wt %) | | (2 wt %) | |
| 23° C., 50% RH | TD | MD | TD | MD |
| Thickness, mil (mm) | 33 (0.8382) | 33 (0.8382) | 29 (0.7366) | 28 (0.7112) |
| Young's modulus, MPa | 1403 | 1378 (24) | 1325 (47) | 1315 (31) |
| Yield stress, MPa | 47.5 (0.69) | 46.8 (0.44) | 41.3 (0.42) | 40.3 (0.54) |
| Yield strain, % | 5.8 (0.27) | 5.5 (0.15) | 5.6 (0.12) | 5.3 (0.08) |
| Break stress, MPa | 42.4 (0.92) | 42.2 (0.64) | 42.3 (1.2) | 42.0 (2.0) |
| Break strain, % | 29.4 (6.7) | 26.7 (3.2) | 45.4 (4.4) | 46.3 (6.2) |

### Example 8. Fatty Acids Miscibility with Plasticized CA-398-30 at TA (<15 Wt %)-Solvent-Cast Films

Films were cast from acetone to assess FA miscibility at TA content lower than 18 wt %.

A 10 wt % solids dope was made in acetone (10% CA-398-30 (10 wt %) or CA-398-30 (9.7 wt %)+FA blend J (3 wt %)). The FA Blend J is a eutectic blend of LA and MA at a 2:1 weight ratio. Triacetin was added to 5, 10, or 15 wt % of solids, and films were cast with a dry thickness of 10 mil. Results are shown in Table 11 below. DSC analysis of the dry films showed at single Tg and no other temperature transitions in the 2nd heat thermogram, an indication of miscibility of the blends. At TA (15 wt %), the addition of FA Blend J (3 wt %) suppressed the Tg slightly.

TABLE 11

| # in this | | FA Blend | Tg (DSC 2^{nd} |
|---|---|---|---|
| series | PZ (wt %) | J (wt %) | heat) (° C.) |
| 1 | TA (15) | — | 112.37 |
| 2 | TA (15) | 3 | 106.51 |
| 3 | TA (10) | 3 | 121.03 |
| 4 | TA (5) | 3 | 139.04 |
| 5 | — | 3 | 159.81 |

### Example 9. Fatty Acids Impact on Melt Rheology of Plasticized CA-398-30 (TA (<15 wt %))-Solvent-Cast Films

The 5 solvent-cast films of Ex 8 were analyzed by melt rheology to estimate melt viscosity. The film samples were tested on an ARES-G2 rotational rheometer using 25 mm parallel plate geometry. A logarithmic frequency sweep test was performed at a constant temperature of 230° C. using a constant deformation strain of 10% over a range of 1-400 rad/s (5 pts/decade). A low shear rate corresponds to a process such as compounding, while a high shear rate corresponds with a process like injection molding. The results are shown in Table 12 below.

TABLE 12

| | | Y Param = | | | | |
|---|---|---|---|---|---|---|
| Avg of Y Values | | poise | | | | |
| | Film # Ex 8 | 1 | 2 | 3 | 4 | 5 |
| | Additives | TA (15 | TA (15 | TA (10 | TA (5 | FA blend |
| | | wt %) | wt %)/FA | wt %)/3 FA | wt %)/FA | J (3 wt %) |
| | | | blend J | blend J | blend J | |
| | | | (3 wt %) | (3 wt %) | (3 wt %) | |
| | Temp (° C., | 230 | 230 | 230 | 230 | 230 |
| | fixed) | | | | | |
| | | Viscosity | Viscosity | Viscosity | Viscosity | Viscosity |
| X Param | X Value | (poise) | (poise) | (poise) | (poise) | (poise) |
| Freq (rad/s) | 1 | 31769.5 | 22757.4 | 43847.9 | 105802 | 455285 |
| | 1.58 | 28867.9 | 21241.4 | 39986.9 | 90188.7 | 350378 |
| | 2.51189 | 25809.3 | 19674.5 | 35897.3 | 75823.7 | 262455 |
| | 3.98107 | 22675.6 | 17874.5 | 31476.9 | 62420.1 | 195939 |
| | 6.30957 | 19660.9 | 16068.1 | 27312.9 | 50374 | 142804 |
| | 10 | 16782.7 | 14212.3 | 23193.6 | 39625.3 | 103630 |
| | 15.8489 | 13976.8 | 12390.7 | 19211.6 | 30513.8 | 74385.8 |
| | 25.1189 | 11394.2 | 10548 | 15524.7 | 23017.5 | 52673.2 |
| | 39.8107 | 9073.75 | 8798.81 | 12253.7 | 16918.9 | 36888.2 |
| | 63.0957 | 7043.5 | 7179.84 | 9420.87 | 12193.9 | 25662 |
| | 100 | 5318.08 | 5730.38 | 7044.52 | 8652.69 | 17734.4 |
| | 158.489 | 3948.7 | 4451.27 | 5172.71 | 6060.7 | 12196.7 |
| | 251.189 | 2798.49 | 3373.04 | 3682.91 | 4164.36 | 8349.34 |
| | 400 | 1955.87 | 2504.13 | 2572.11 | 2837.8 | 5701.01 |

### Example 10. Compounding CA-398-30 with FA Blend J (3 wt %) and Triacetin (15 wt % or Less)

Formulations were compounded as in Ex 4, but with the compositions shown in Table 13 below:

TABLE 13

| | CA398-30 | Vikoflex | Triacetin | |
|---|---|---|---|---|
| Sample # | (wt %) | (wt %) | (wt %) | FA Blend (wt %) |
| 13-1 | 84 | 1 | 15 | — |
| 13-2 | 81 | 1 | 15 | FA Blend J (3) |
| 13-3 | 86 | 1 | 10 | FA blend J (3) |
| 13-4 | 91 | 1 | 5 | FA blend J (3) |
| 13-5 | 96 | 1 | — | FA blend J (3) |
| 13-6 | 89 | 1 | 10 | — |
| 13-7 | 86 | 1 | 10 | FA blend J (3) |
| 13-8 | 86 | 1 | 10 | FA Blend K [lauric |
| | | | | acid:palmitic acid |
| | | | | 2:1] (3) |
| 13-9 | 79 | 1 | 20 | — |
| 13-10 | 86.5 | 1 | 12.5 | — |
| 13-11 | 81 | 1 | 15 | FA Blend J (3 wt %) |

The fatty acid additive FA blend J. FA blend J was pre-blended separately for each batch. Flexbars (125 mil (3.175 mm)) were injection molded and 10 mil (0.0254 mm) film was extruded from each batch of compounded pellets from Table 4.

### Example 11. FA Impact on TA Loss During Film Extrusion

The triacetin content of 10 mil (0.0254 mm) films and flex bars from Ex 10 was determined by GC after extraction. A known weight of internal standard is added to a known weight of sample. Acetone is added to dissolve the sample and after the sample is dissolved, heptane is added to precipitate the cellulose ester. A filtered aliquot of the prepared sample is then chromatographed on a DB-1 column. The concentrations of sample components are calculated from the integrated chromatogram by internal standardization. Triacetin is semi-volatile and is sometimes lost from melt-extruded films due to the high heat of the process and the large surface area of the film. The flex bars and the 10 mil extruded films were made from the same batch of pellets. When the FA additive is present at 3 wt %, the TA level is the same in both articles. Results are shown in Table 14 below.

TABLE 14

| | | | | |
|---|---|---|---|---|
| | Measured TA in | | | |
| Measured TA in | 10 mil (0.254 | TA | Additive | |
| Flexbars (wt %) | mm) films (wt %) | (wt %) | (wt %) | % |

| | | | |
|---|---|---|---|
| 12.5 | 10.1 | 15 | — |
| 12.66 | 12.5 | 15 | FA blend J (3) |
| 8.24 | 8.3 | 10 | FA Blend J (3) |
| 3.97 | 4.1 | 5 | FA blend J (3) |

### Example 12. Impact of FA on Tensile Properties of 10 Mil Film

Tensile properties of the 10 mil (0.254 mm) film of Ex 10 were measured according to ASTM D882 with the results shown in Table 15 and 16 below. Of the film tensile properties in Table 16, the biggest differences among the formulations may be seen in the Break strain values, or % elongation at break. In films with TA (15 wt %), there is evidence of molecular orientation formed during film extrusion, as the Break strain is very different depending on the direction tested. In contrast, adding FA blend J (3 wt %) along with TA (15 wt %) not only increases the Break strain, but also seems to reduce molecular orientation.

TABLE 15

| | ASTM D882/FILM | | | |
|---|---|---|---|---|
| | Sample 13-1 | | Sample 13-2 | |
| 23° C., 50% RH | TD | MD | TD | MD |
| Thickness, mil (mm) | 11 (0.2794) | 10 (0.254) | 10 (0.254) | 10 (0.254) |
| Young's modulus, MPa | 2076 | 2236 (84) | 1960 (43) | 2004 (58) |
| Yield stress, MPa | 42.3 (1.1) | 60.8 (1.8) | 51.3 (0.84) | 52.3 (1.2) |
| Yield strain, % | 2.8 (0.14) | 5.1 (0.12) | 4.5 (0.17) | 4.7 (0.19) |
| Break stress, MPa | 41.5 (1.9) | 61.8 (2.4) | 51.4 (3.7) | 56.4 (1.3) |
| Break strain, % | 6.4 (1.4) | 40.8 (3.6) | 48.7 (5.9) | 53.3 (3.6) |

Furthermore, the addition of FA blend J (3 wt %) permits lower loading of primary plasticizer. The tensile properties of film from Sample 13-3 is very close to the properties of Sample 13-1.

TABLE 16
Tensile properties of 10 mil film

| | ASTM D882/FILM | | | | | | | | | | | |
|---|---|---|---|---|---|---|---|---|---|---|---|---|
| | Sample 13-3 | | | | Sample 13-4 | | | | Sample 13-5 | | | |
| 23 C., 50% RH | TD | | MD | | TD | | MD | | TD | | MD | |
| Thickness, | 10 | (0.254) | 10 | (0.254) | 16 | (0.4064) | 10 | (0.254) | 13 | (0.3302) | 12 | (0.3048) |
| mil (mm) | | | | | | | | | | | | |
| Young's | 1993 | | 2186 | (118) | 2063 | (85) | 2524 | (83) | 2190 | (210) | 3283 | (113) |
| modulus, | | | | | | | | | | | | |
| MPa | | | | | | | | | | | | |
| Yield stress, | 52.3 | (1.0) | 61.1 | (1.9) | 65.6 | (3.2) | 73.0 | (2.0) | 40.9 | (11.9) | 93.0 | (12.9) |
| MPa | | | | | | | | | | | | |
| Yield strain, % | 4.4 | (0.14) | 5.2 | (0.28) | 5.3 | (0.19) | 5.2 | (0.33) | 3.0 | (2.0) | 4.0 | (0.88) |
| Break stress, | 47.1 | (1.6) | 60.2 | (3.5) | 59.4 | (2.6) | 72.5 | (2.6) | 40.9 | (11.9) | 93.0 | (12.9) |
| MPa | | | | | | | | | | | | |
| Break strain, % | 14.6 | (5.2) | 38.2 | (4.8) | 9.6 | (1.5) | 21.8 | (3.1) | 3.0 | (2.0) | 4.0 | (0.88) |

### Example 13. FA Additive Effect on HDT

The low pressure (LPRS) HDT of flex bars from Ex 10 was measured after equilibration at 20° C. and 50% RH, according to ASTM D648. Results are shown in Table 17. The LPRS HDT of flex bars from Sample 13-3 is more than 10 degrees higher to the value of Sample 13-1 measured at 50% RH.

TABLE 17

| Sample # | LPRS HDT/50% RH |
|---|---|
| 13-1 | 98 |
| 13-2 | 89 |
| 13-3 | 109 |
| 13-4 | 127 |
| 13-5 | 148 |

### Example 14. Compression Resistance of 10 Mil Film

Heated compression tests were performed on extruded films (10 mil (0.254 mm)) representing each of the test formulations Samples 13-2, 13-3, 13-4, and 13-9 as described in Table 18. The compression test was designed to mimic conditions experienced during normal use for a hot beverage lid. After pouring heated water into a coated paper cup, a test film was fixed on top. The rigidity of the film was monitored over time as the water condensed on the underside of the lid and cooled in the cup. HIPS is a common material used for thermoformed single use coffee cups and was selected as a positive control. CA-398-30 plasticized with TA (20 wt %) served as a negative control.

TABLE 18

| | Sample # | | | | |
|---|---|---|---|---|---|
| | HIPS | 13-9 | 13-2 | 13-3 | 13-1 |
| Time (min) | Resistance (N) | | | | |
| 0 | 30.0 | 25.3 | 24.0 | 27.3 | 52.0 |
| 2.5 | 30.3 | 11.5 | 18.0 | 26.0 | 45.0 |
| 5 | 31.5 | 11.8 | 19.3 | 29.0 | 48.0 |
| 10 | 33.8 | 11.5 | 23.3 | 33.0 | 55.8 |
| 15 | 34.0 | 12.3 | 25.0 | 35.0 | 58.3 |
| 20 | 34.0 | 12.5 | 26.5 | 36.0 | 61.5 |

### Example 15. FA Effect on HDT at 100% RH

The low pressure (LPRS) HDT of flex bars from Ex 10 and similar formulations was measured after equilibration at 20° C. and 50% RH and separately after 48 h equilibration at 20° C. and 100% RH. The LPRS HDT of flex bars does not change when FA (3 wt %) is included in the formulation. Therefore, while a formula with TA (10 wt %)+FA (3 wt %) processes like a formula with TA (15 wt %), the HDT is higher at 100% RH.

TABLE 19
Low Pressure HDT of flex bars equilibrated at 100% RH

| Sample # | LPRS HDT/100% RH |
|---|---|
| 13-1 | 62 |
| 13-2 | 53 |
| 13-3 | 65 |
| 13-4 | 68 |
| 13-5 | 75 |
| 13-6 | 69 |
| 13-7 | 68 |
| 13-8 | 59 |

### Example 16. Lid Leak Test (Dimensional Stability)

Sample 13-7 with TA (10 w %) and FA blend J (3 wt %) was extruded as 15 mil (0.381 mm) sheet and thermoformed into cup lids as in Ex 19. The lids were tested for lid fit and dimensional stability over an extended time during simulated use. A 12-ounce Dixie cup (insulated coated paper) was filled with either cold tap water or hot (83° C.) water to a level ˜1 cm below the rim. A test lid (with a vent hole) was placed on the cup. The cup was tilted so that water was touching part of the lid (about a 30-degree tilt) and held in this position for 20 min with a clamp. The number of drops of water that leaked in 20 min was recorded and reported in Table 20. Only a few drops of water (either cold or hot) leaked from the test lid over the course of 20 min. This was comparable to or better than the performance of commercially available lids that also fit the cup well.

TABLE 20
Results of the leak test.

| | Cold Water | Hot Water (83° C.) |
|---|---|---|
| Lid description, thickness range | Drops/20 min | Drops/20 min |
| Black Karat polypropylene lid, | 6 | 14 |
| 9-19 mil (0.2286-0.4826 mm) | | |
| Gray Dixie polystyrene lid, | 0 | 45 |
| 11-14 mil (0.2794-0.3556 mm) | | |
| Test formulation (Sample 13-7), | 5 | 7 |
| 11-15 mil (0.2794-0.3981 mm) | | |

### Example 17. Disintegration in Compost (10 Mil (0.254 mm) Sheet)

Extruded sheet from Ex 10, 10 mil (0.254 mm) thickness, was screened for disintegration in Industrial compost conditions, according to ISO20200. The 12-week test is conducted at 58° C. The test samples are considered to pass if the % disintegration is >90% by the end of the test.

TABLE 21
Disintegration results for 10 mil sheets
made from Samples 13-1 to 13-4.

| Sample # | Disintegration in compost |
|---|---|
| 13-1 | 100% |
| 13-2 | 99% |
| 13-3 | 100% |
| 13-4 | 94% |

### Example 18. Formulated CA with FA Processed by Batch Foaming

### Batch Foaming

The film samples (from Ex 10) with compositions listed in Table 13 were foamed in batch foaming using CO₂ as blowing agent.

Batch foaming technique is a good screening tool to assess general foamability of various foam formulations before going to large scale continuous line extruder. It is capable to be used for foaming using various blowing agents such as CO₂, hydrocarbons, water, and other blowing agents. The foam produced may be useful to indicate processing trends such as the effect of temperature, the effect of pressure, trends with density that may be useful during larger scale processing. Additionally, the generated foam can indicate attainable foam material properties such as density, cell size, cell wall thickness, and cell connectivity.

### Description of Batch Foaming Procedure

Batch foaming was conducted in a 300-mL high-pressure autoclave (Parr Instrument Company Model No. 4561) with a diameter of 2.5 inches and a depth of 4 inches equipped with thermocouple. The diptube, agitator shaft, and impeller were removed. In a typical experiment, three to four 10-mil (0.254 mm) films (1 inch×1 inch) (25.4 mm×25.4 mm) were placed on custom-made trays (L×W×H, 1.5×1.5×0.5 inches) (L×W×H, 38.1 mm×38.1 mm×38.1 mm) stacked inside the autoclave. Each tray contains one film and the trays were stacked on top of each other. The tray was made by folding Teflon-lined film into the desired dimensions. The vessel was closed, tightly sealed, and then heated to the desired temperature, which may range from 150 to 230° C. After the desired temperature was reached, CO₂ gas was pumped into the vessel to the desired pressure (for example 130 bar) by opening the CO₂ supply valve. At the completion of CO₂ delivery, the vessel temperature will drop. The vessel was let to stabilize at desired dwell temperature. After stabilization, the vessel was let to dwell for 30 mins to allow for CO₂ gas penetration into the films. After completion of the dwell time, the pressure was quickly released through a fully opened valve on a 0.25 inch (6.35 mm) vent pipe while purging with nitrogen. The vessel was let to cool to room temperature and the foamed films were retrieved and their densities were measured. The cell structures were characterized by scanning electron microscopy and measured using ImageJ software.

### Procedure for Density Measurement

The foamed films were broken into approximately 4 cm×1 cm pieces. The weight was measured on a weighing scale and the films were submerged into water contained in 20-mL vial. The volume displaced as the result of submersion was measured. The density is calculated by foamed film weight divided by volumes of water displaced.

The table below list the formulation, foaming conditions used for foaming and the densities and cell sizes obtained.

TABLE 22
List of Fatty Acid-Containing Formulations, Foaming
Conditions, and Resulting Foam Properties.

| | | Temp | Density | Cell Sizes |
|---|---|---|---|---|
| Sample # | Conditions | (° C.) | (g/L) | (μm) |
| 13-1 | CO₂, 130 bar, 30 min | 200 | 210 | 28 ± 6 |
| 13-2 | CO₂, 130 bar, 30 min | 200 | 215 | 20 ± 7 |
| 13-3 | CO₂, 130 bar, 30 min | 220 | 202 | 26 ± 6 |
| 13-4 | CO₂, 130 bar, 30 min | 220 | 87 | 47 ± 1 |
| 13-5 | CO₂, 130 bar, 30 min | 225 | 148 | 37 ± 11 |

### Observations on Batch Foaming

The above results demonstrate that (1) addition of fatty acid did not significantly alter foam characteristics that were produced (compare sample 1 and 2), (2) materials with lower plasticizer concentrations at 10 wt % and at 5 wt % TA can be foamed to yield foam with low cell size characteristics (30-50 microns) using batch foaming (Samples 3-5), which indicate material's foamability at larger scale.

### Example 19. Thermoforming Cup Lids

### Thermoforming Process

Sheets of film (˜11″×16″) (27.94 cm×40.64 cm) of Example 10 were thermoformed on a Hydrotrim single stage thermoformer into cup lids. A single film is placed into a frame and subsequently clamped. After the film is secured into the frame, the process starts with the clamped sheet/film retracting into an oven. The oven temperature is typically set between 450°-550° F. (450.2° C.-287.8° C.). It's most desirable to be at hot as possible without the film sagging so much that it contacts the bottom of the oven. The upper end of our sheet temp is ˜430° F. (˜221.1° C.) for maximum sag and optimal thermoformability. Oven time is adjusted based on the composition and thickness of the film being thermoformed.

Once the film has finished the heating cycle, it ejects from the thermoforming oven. The heated film comes to rest over an aluminum cup lid mold. After the film comes to rest, the mold immediately extends into the heated sheet/film. As the mold is pushed into the heated film, vacuum is applied for ˜10 seconds. After the vacuum cycle is complete, the mold retracts. The finished thermoformed article can then be removed for the machine.

TABLE 23

| Sample | | Film | Lid | Thermoforming |
|---|---|---|---|---|
| # | Formulation | Thickness | Thickness | Conditions |
| 13-10 | CA398-30/TA | 10 mil | 6-10 mil | 22 s/max sag/ |
| | (12.5 wt %)/ | (0.254 mm) | (0.1524- | ST 420° F. |
| | Vikoflex (1 | | 0.254 mm) | (215.6^{p} C.) |
| | wt %) | | | |
| 13-3 | CA398-30/TA | 10 mil | 3-10 mil | 22 s/max sag/ |
| | (8.2 wt %)/ | (0.254 mm) | (0.0762- | ST 425° F. |
| | Vikoflex (1 | | 0.254 mm) | (218.3° C.) |
| | wt %)/ FA | | | |
| | Blend J | | | |
| | (3 wt %) | | | |

### Example 20. Profile Extrusion of Straws

The Sample 13-11 (Table 13) was compounded according to Ex 4 to generate 150 lbs of pellets. The pellets were profile extruded to make drinking straws on a commercial profile extrusion line. The extruder zone temperature ranged from 440 to 470° F. (226.7 to 243.3° C.), with a die temperature of 460° F. (237.8° C.). The line speed was 400 feet per min. The straws were clear and ductile.

1. A melt-processable cellulose acetate composition, said composition comprising (i) cellulose acetate; (ii) fatty acid, and (iii) an optional processing aid, wherein said fatty acid is a fatty acid blend and wherein the fatty acid components of said blend have an alkyl chain length no more than C16.″

2. The melt-processable cellulose acetate composition of claim 1 wherein said composition comprises a processing aid and wherein said processing aid is a plasticizer which is present in an amount of from 1% to 40% by weight based on the total weight of said melt-processable cellulose acetate composition.

3. The melt-processable cellulose acetate composition of claim 1 wherein said fatty acid is present in an amount from 0.5 to 5% by weight based on the total weight of said melt-processable cellulose acetate composition.

4. The melt-processable cellulose acetate composition of claim 1 wherein said fatty acid is selected from the group consisting of lauric acid, myristic acid, palmitic acid, stearic acid and blends thereof.

5. The melt-processable cellulose acetate composition of claim 1 wherein said fatty acid is a blend or a eutectic blend of two or more fatty acids.

6. The melt-processable cellulose acetate composition of claim 5 wherein said eutectic blend is a binary eutectic blend or ternary eutectic blend.

7. The melt-processable biodegradable cellulose acetate composition of claim 1 wherein said fatty acid has an alkyl chain length range of C12 to C16.

8. The melt-processable cellulose acetate composition of claim 1 wherein said fatty acid is a fatty acid blend with an onset melt temperature below 70° C.

9. The melt-processable cellulose acetate composition of claim 5 wherein said eutectic blend has a melt temperature below 50° C.

10. The melt-processable cellulose acetate composition of claim 1 wherein said fatty acid has a saturated alkyl chain.

11. The melt-processable cellulose acetate composition of claim 2 wherein said plasticizer is selected from the group consisting of triacetin, triethyl citrate, polyethylene glycol having an average weight average molecular weight of from 200 to 1000 Da and combinations thereof.

12. The melt-processable cellulose acetate composition of claim 1 further comprising one or more of a UV absorber, an antioxidant, an acid or radical scavenger, an epoxidized oil and combinations thereof.

13. The melt-processable composition of claim 1 wherein said composition is a foamable composition further comprising at least one blowing agent and optionally at least one nucleating agent.

14. A cellulose acetate melt comprising or formed from or prepared using the melt-processable composition of claim 1.

15. A melt-formed article comprising or formed from or prepared using the melt-processable composition of claim 1.

16. The article of claim 15 wherein said article is an injection molded article, a compression molded article, an extruded article, a profile extruded article,
or a thermoformed article.

17. An article comprising a foam comprising, formed from or prepared using the melt of claim 14.

18. The melt-processable cellulose acetate composition of claim 1 further comprising one or more fatty acid esters.

19. The composition of claim 1, wherein the composition or article is compostable, biodegradable, or disintegrable.
